(19) United States
(12) Patent Application Publication
(10) Pub. No.: US 2025/0303690 A1
(43) Pub. Date: Oct. 2, 2025

(54) PLATEN AND PRESS UNIT

(71) Applicant: BROTHER KOGYO KABUSHIKI KAISHA, Nagoya (JP)

(72) Inventors: Takuro YAMAZAKI, Anjo (JP); Daisuke KAWASE, Konan (JP); Shuichi TAMAKI, Nagoya (JP); Tetsuro KOBAYASHI, Nagoya (JP)

(21) Appl. No.: 19/077,812

(22) Filed: Mar. 12, 2025

(30) Foreign Application Priority Data
Mar. 27, 2024 (JP) 2024-050870

(51) Int. Cl. B41F 1/38; B41F 1/22

(52) U.S. Cl. CPC B41F 1/38; B41F 1/22

(57) ABSTRACT

A platen includes a platen plate, a platen support base, and a press surface. The platen plate includes a placement surface facing upward. A print medium is placed on the placement surface. The platen support base is disposed lower than the platen plate and includes a support pillar supporting the platen plate from below. The press surface is provided higher than a lowermost surface of the platen support base. The press surface faces downward and is configured for a press head to come into contact with the press surface when the press head performs pressing operation in a set state in which the platen is set on the press head.

### REFERENCE TO RELATED APPLICATIONS

This application claims priority from Japanese Patent Application No. 2024-050870 filed on Mar. 27, 2024. The entire content of the priority application is incorporated herein by reference.

### BACKGROUND ART

In a printer, a print medium is placed on a platen. The platen is supported by a slide rail via a slider and a raising/lowering device, and is conveyed along the slide rail. The print medium is pressed by a press machine.

### SUMMARY

For example, in order to reduce man hours, it is conceivable to press the print medium using the press machine in a state in which the print medium is placed on the platen. In this case, when the press machine presses from above the platen, there is a possibility that pressure may be applied to the slide rail and the slide rail may deform. Thus, it is conceivable for the press machine to press the platen from below. In this case, when the press machine comes into contact with a lowermost surface of the slider and the raising/lowering mechanism, and presses the lowermost surface upward, there is a possibility that the slider and the raising/lowering mechanism as a whole may deform. It is thus necessary to increase the rigidity of the slider and the raising/lowering mechanism as a whole.

Embodiments of the broad principles derived herein provide a platen and a press unit that contribute to suppressing an increase in rigidity of a product as a whole that is to be lifted when being pressed.

A first aspect of the present disclosure relates to a platen. The platen is configured to be set on a press head. The press head is configured to perform a pressing operation of pressing upward against a fixed plate. The platen includes a platen plate including a placement surface. The placement surface faces upward. The placement surface is configured to have a print medium placed on the placement surface. The platen includes a platen support base disposed lower than the platen plate. The platen support base includes a support pillar. The support pillar supports the platen plate from below. The platen includes a press surface provided higher than a lowermost surface of the platen support base. The press surface faces downward. The press surface is configured for the press head to come into contact with the press surface when the press head performs the pressing operation in a set state. The set state is a state in which the platen is set on the press head.

According to the first aspect, the press surface is provided to be higher than the lowermost surface of the platen support base. Pressure generated by the pressing operation is less likely to act on portions, of the platen support base, that are lower than the press surface, compared to portions that are higher than the press surface. Thus, of the platen support base, compared to the portions that are higher than the press surface, rigidity for resisting the pressure generated by the pressing operation is not required with respect to the portions that are lower than the press surface. As a result, the platen contributes to suppressing an increase in the rigidity of the platen as a whole.

A second aspect of the present disclosure relates to a press unit. The press unit includes a press machine including a press head. The press head is configured to perform a pressing operation of pressing upward with respect to a fixed plate. The press unit includes a platen configured to be set on the press head. The platen includes a platen plate including a placement surface. The placement surface faces upward. The placement surface is configured to have a print medium placed on the placement surface. The platen includes a platen support base disposed lower than the platen plate. The platen support base includes a support pillar. The support pillar supports the platen plate from below. The platen includes a press surface provided higher than a lowermost surface of the platen support base. The press surface faces downward. The press surface is configured for the press head to come into contact with the press surface when the press head performs the pressing operation in a set state. The set state is a state in which the platen is set on the press head.

The second aspect contributes to the same advantages as the first aspect.

### BRIEF DESCRIPTION OF DRAWINGS

FIG. 1 is a perspective view of a platen as seen from the front right and above.

FIG. 2 is a perspective view of the platen as seen from the rear left and below.

FIG. 3 is a perspective view of the platen as seen from the front right and above.

FIG. 4 is a right side view of the platen.

FIG. 5 is a front view of the platen.

FIG. 6 is a cross-sectional view of the platen in the direction of arrows along a line VI-VI shown in FIG. 5.

FIG. 7 is a plan view schematically showing a print system.

FIG. 8 is a perspective view of a printer as seen from the front left and above.

FIG. 9 is a cross-sectional view of the printer as seen from the right when cut in a plane, orthogonal to the left-right direction, passing through a shaft shown in FIG. 8.

FIG. 10 is a plan view of a state in which the platen is set on a mounting portion.

FIG. 11 is a perspective view, as seen from the front right and above, of a press machi with a shutter disposed at an open position.

FIG. 12 is a perspective view, as seen from the front right and above, of the press machine with the shutter disposed at a closed position.

FIG. 13 is a perspective view of a device main body as seen from the front left and above.

FIG. 14 is a perspective view of the device main body as seen from the rear left and above.

FIG. 15 is a perspective view, as seen from the rear left and above, of the platen set on a press head.

FIG. 16 is a plan view of a state in which the platen is set on the press head.

FIG. 17 is a front view of a state in which the platen is set on the press head, and a moving portion is disposed at a stand-by position.

FIG. 18 is a right side view of the device main body in a state in which the platen is set on the press head, and the moving portion is disposed at the stand-by position.

FIG. 19 is a right side view of the device main body in a state in which the platen is set on the press head, and the moving portion is disposed at a pressing position.

FIG. 20 is a block diagram showing an electrical configuration of the print system.

FIG. 21 is a flowchart of main processing.

FIG. 22 is a cross-sectional view of a platen as seen in the direction of the arrows along the line VI-VI shown in FIG. 5.

### DESCRIPTION

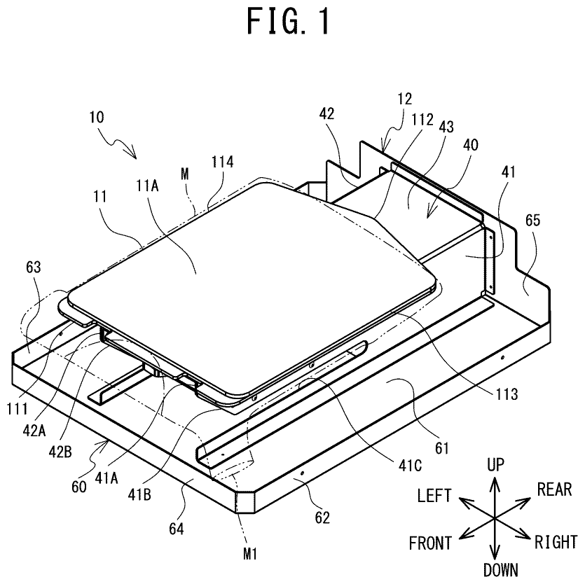

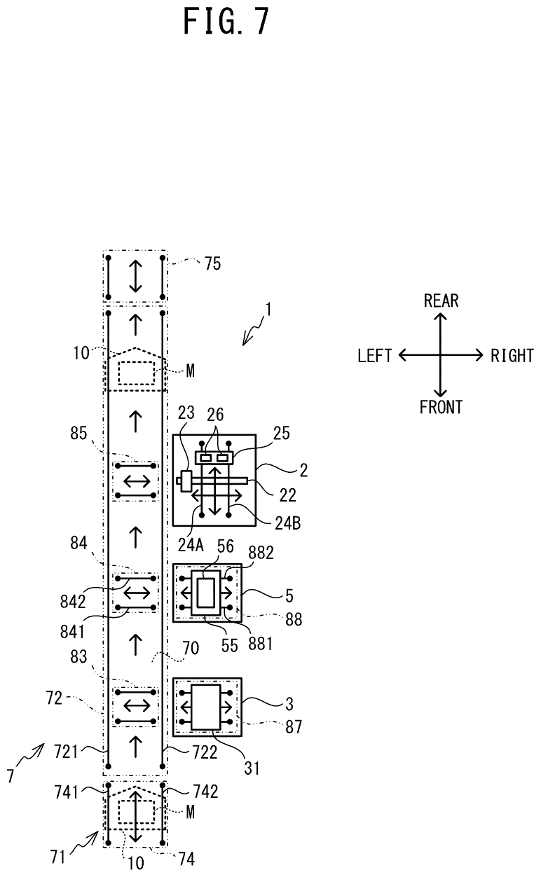

An embodiment of the present disclosure will be described with reference to the drawings. In the present embodiment, mechanical elements in the drawings indicate an actual scale. A platen 10 shown in FIG. 1 is used in a print system 1 shown in FIG. 7. The print system 1 performs printing on a print medium M. The print medium M is a cloth, paper, or the like, and is a T-shirt, for example.

The platen 10 will be described with reference to FIG. 1 to FIG. 6. In the description of the platen 10, the upper left direction, the lower right direction, the lower left direction, the upper right direction, the upward direction, and the downward direction in FIG. 1 are, respectively, the left direction, the right direction, the front direction, the rear direction, the upward direction, and the downward direction of the platen 10.

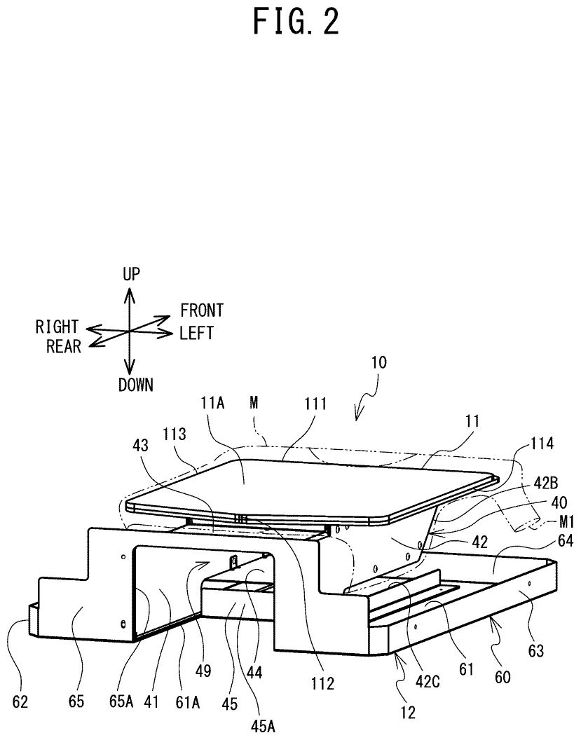

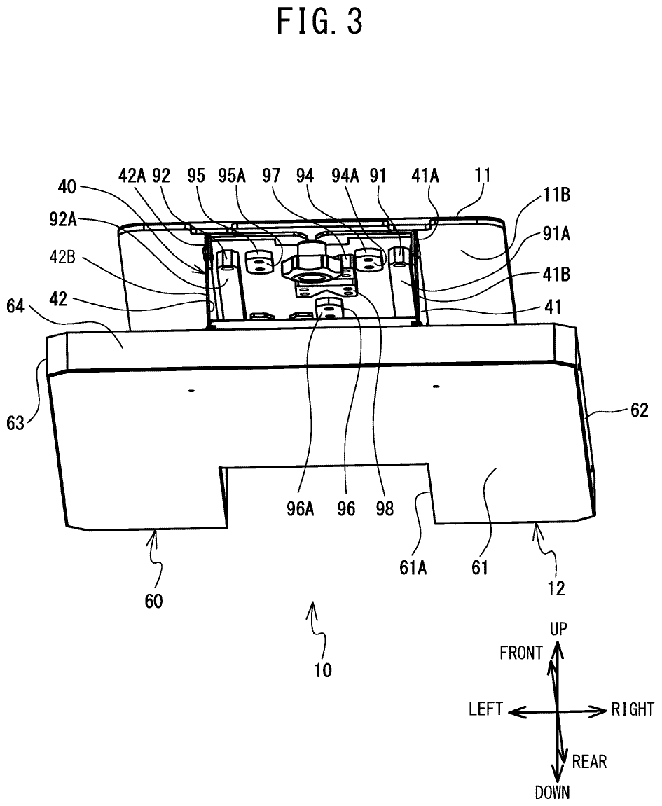

As shown in FIG. 1 to FIG. 3, the platen 10 is provided with a platen plate 11, and a support base 12. The platen plate 11 is disposed on the upper end of the platen 10. As shown in FIG. 1 and FIG. 2, the platen plate 11 extends in the front-rear direction and the left-right direction, and has a pentagonal shape in a plan view. The platen plate 11 includes a placement surface 11A and a lower surface 11B shown in FIG. 3.

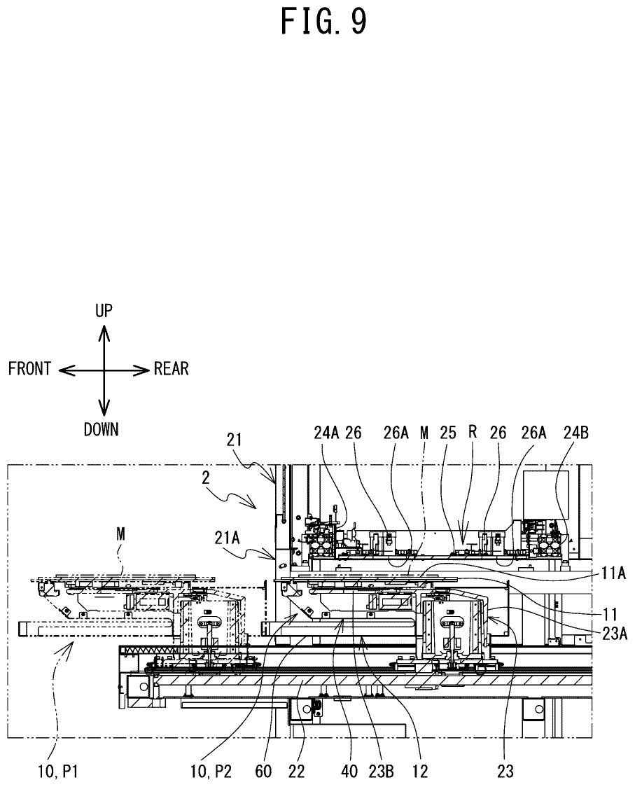

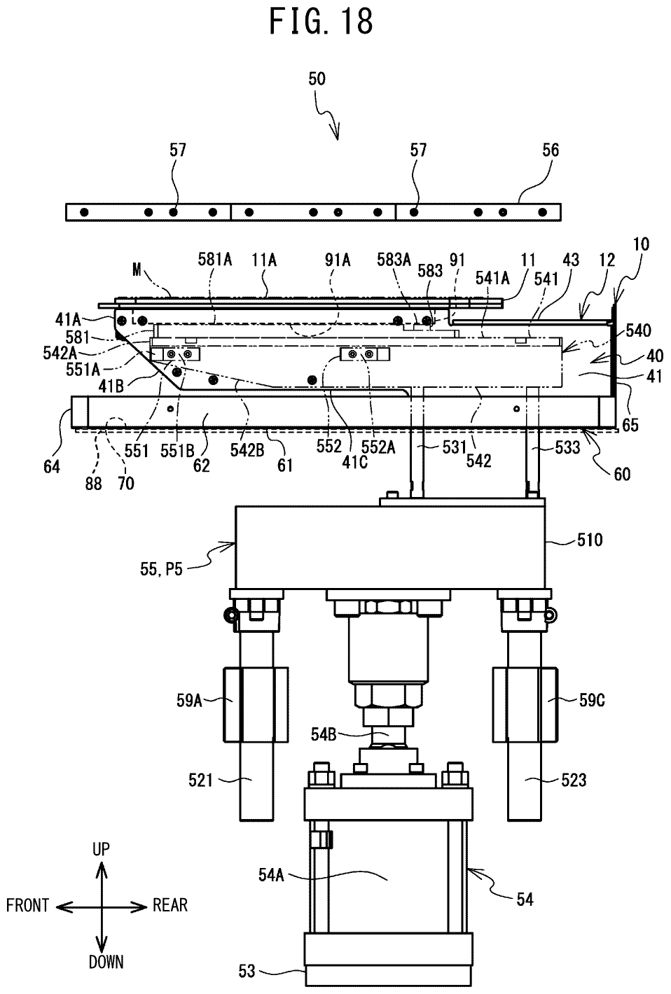

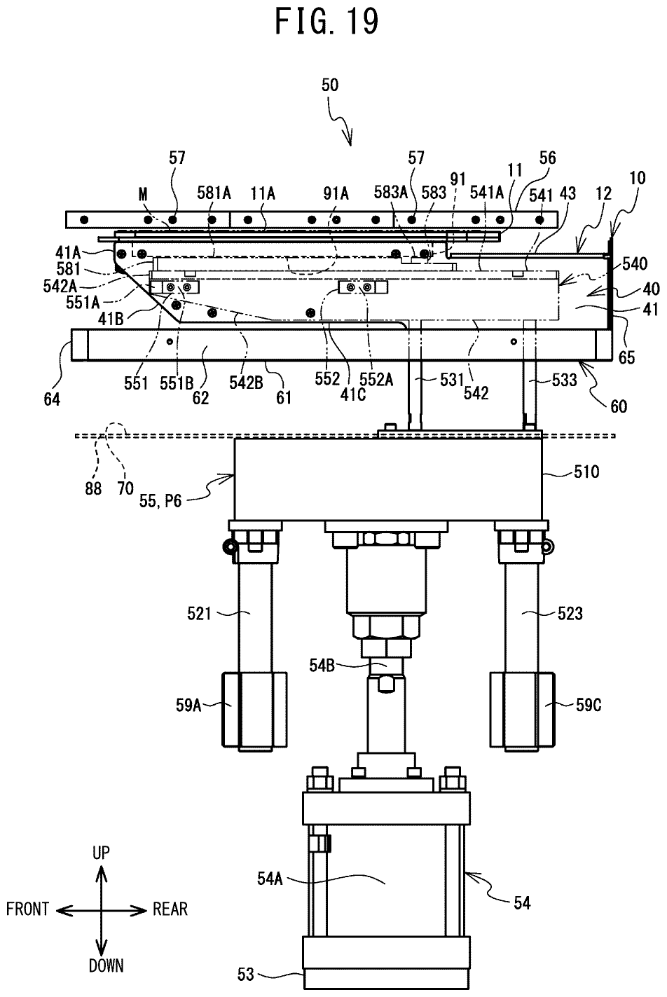

The placement surface 11A is provided on the upper surface of the platen plate 11. The placement surface 11A has a flat surface shape, and faces upward. The print medium M is placed on the placement surface 11A. Hereinafter, the print medium M is placed on the placement surface 11A will also sometimes be referred to as “the print medium M is set on the platen 10”. The print medium M set on the platen 10, namely, the print medium M placed on the placement surface 11A will also sometimes be referred to as the “print medium M on the platen plate 11”. In the drawings other than FIG. 1, FIG. 2, FIG. 7, FIG. 9, FIG. 18, and FIG. 19, illustration of the print medium M is omitted. In the present embodiment, when the print medium M is the T-shirt, for example, the print medium M is set on the platen 10 such that the neckline of the T-shirt is oriented toward the front of the platen 10. In this case, a front end 111 of the platen plate 11 is inserted into the body of the T-shirt via the hem of the T-shirt. Note that the print medium M may be set on the platen 10 such that the neckline is oriented toward the rear of the platen 10.

As shown in FIG. 3, the lower surface 11B is the surface on the opposite side from the placement surface 11A of the platen plate 11, in the up-down direction, and is parallel to the placement surface 11A. The lower surface 11B has a flat surface shape, and faces downward.

As shown in FIG. 1 to FIG. 3, the support base 12 is the whole of a portion disposed lower than the platen plate 11, of the platen 10. The support base 12 is provided with a support pillar 40 and a tray 60. The support pillar 40 extends downward from the platen plate 11, and supports the platen plate 11 from below. The support pillar 40 includes a right plate 41, a left plate 42, an upper plate 43, a connection plate 44 shown in FIG. 2, and a contact plate 45 shown in FIG. 2. The right plate 41 is disposed at the right end of the support pillar 40.

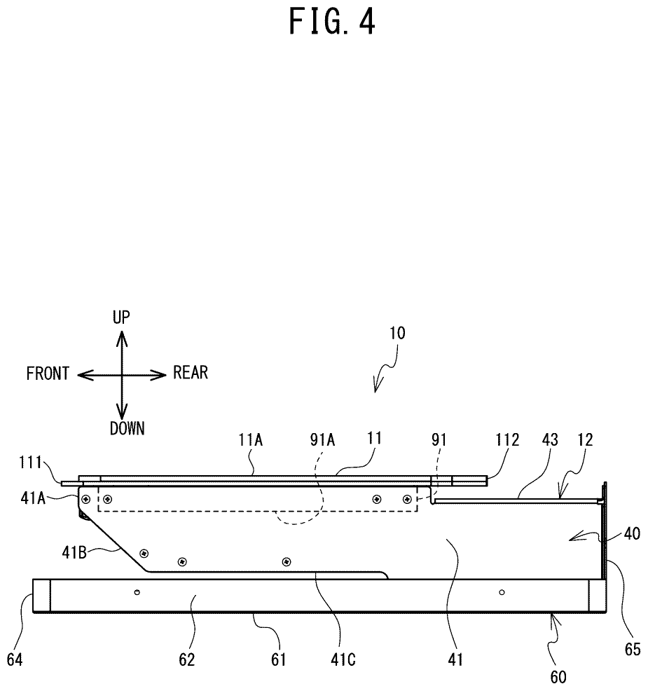

As shown in FIG. 1 and FIG. 4, the right plate 41 extends downward from the platen plate 11, and extends in the front-rear direction. The right plate 41 extends from a position further to the rear than the front end 111 of the platen plate 11, to a position further to the rear than a rear end 112 of the platen plate 11. The front end of the right plate 41 is disposed at the front end of the support pillar 40.

A perpendicular portion 41A, an inclined portion 41B, and a cutout portion 41C are provided at the front end of the right plate 41. The perpendicular portion 41A extends downward from the upper end of the right plate 41. The inclined portion 41B extends from the lower end of the perpendicular portion 41A so as to be inclined downward the further toward the rear. The cutout portion 41C extends to the rear from the lower end of the inclined portion 41B, and partially cuts through the right plate 41.

As shown in FIG. 2, the left plate 42 is disposed at the left end of the support pillar 40, aligned to the left with the right plate 41. The shape of the left plate 42 is the same as that of the right plate 41. The left plate 42 extends downward from the platen plate 11, and extends in the front-rear direction. The left plate 42 extends from a position further to the rear than the front end 111 of the platen plate 11 to a position further to the rear than the rear end 112 of the platen plate 11.

The front end of the left plate 42 is disposed at the same position as the front end of the right plate 41 in the front-rear direction, and is disposed at the front end of the support pillar 40. A perpendicular portion 42A shown in FIG. 3, an inclined portion 42B, and a cutout portion 42C are provided at the front end of the left plate 42. The perpendicular portion 42A shown in FIG. 3 extends downward from the upper end of the left plate 42. The inclined portion 42B extends from the lower end of the perpendicular portion 42A so as to be inclined downward the further toward the rear. The cutout portion 42C extends to the rear from the lower end of the inclined portion 42B, and partially cuts through the left plate 42.

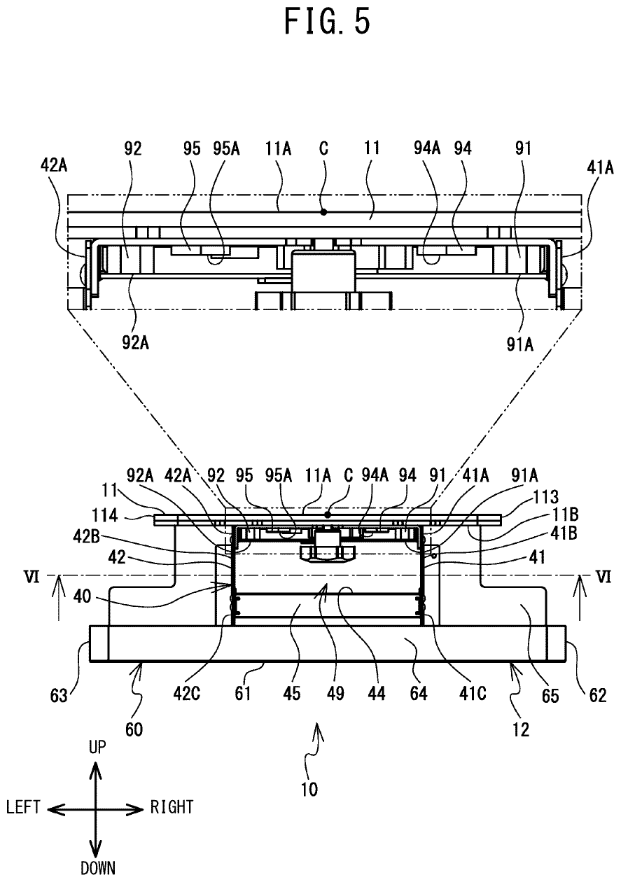

As shown in FIG. 5, a center line C is a virtual straight line passing through a center between a right end 113 and a left end 114 of the platen plate 11 in the left-right direction, and extending in the front-rear direction. The right plate 41 is disposed between the center line C and the right end 113 of the platen plate 11 in the left-right direction. The left plate 42 is disposed between the center line C and the left end 114 of the platen plate 11 in the left-right direction. In the left-right direction, a distance from the center line C to the right plate 41 and a distance from the center line C to the left plate 42 are the same as each other. The right plate 41 and the left plate 42 are provided at positions where the center line C interposed therebetween in the left-right direction.

As shown in FIG. 1 and FIG. 2, the upper plate 43 is disposed at the rear portion of the support pillar 40, and extends in the front-rear direction and the up-down direction. The right end of the upper plate 43 is connected to the upper end of the right plate 41. The left end of the upper plate 43 is connected to the upper end of the left plate 42.

As shown in FIG. 2, the connection plate 44 is disposed between the right plate 41 and the left plate 42, and extends in the front-rear direction and the left-right direction. The connection plate 44 is disposed above and in proximity to the cutout portions 41C and 42C. The right end of the connection plate 44 is connected to the right plate 41. The left end of the connection plate 44 is connected to the left plate 42. The front end of the connection plate 44 is disposed further to the rear than each of the inclined portions 41B and 42B. The rear end of the connection plate 44 is disposed in the vicinity of the rear ends of each of the cutout portions 41C and 42C.

The contact plate 45 is disposed between the right plate 41 and the left plate 42. The contact plate 45 extends downward from the rear end of the connection plate 44, and extends in the left-right direction. The right end of the contact plate 45 is connected to the right plate 41. The left end of the contact plate 45 is connected to the left plate 42. The lower end of the contact plate 45 is disposed at the same position as the lower ends of each of the right plate 41 and the left plate 42.

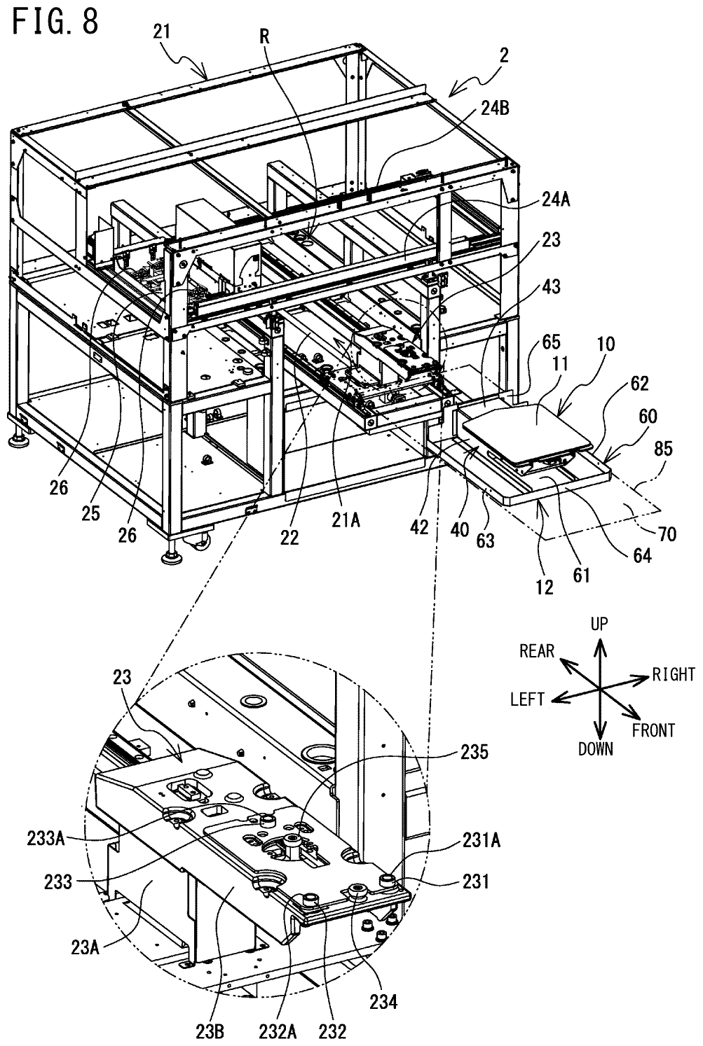

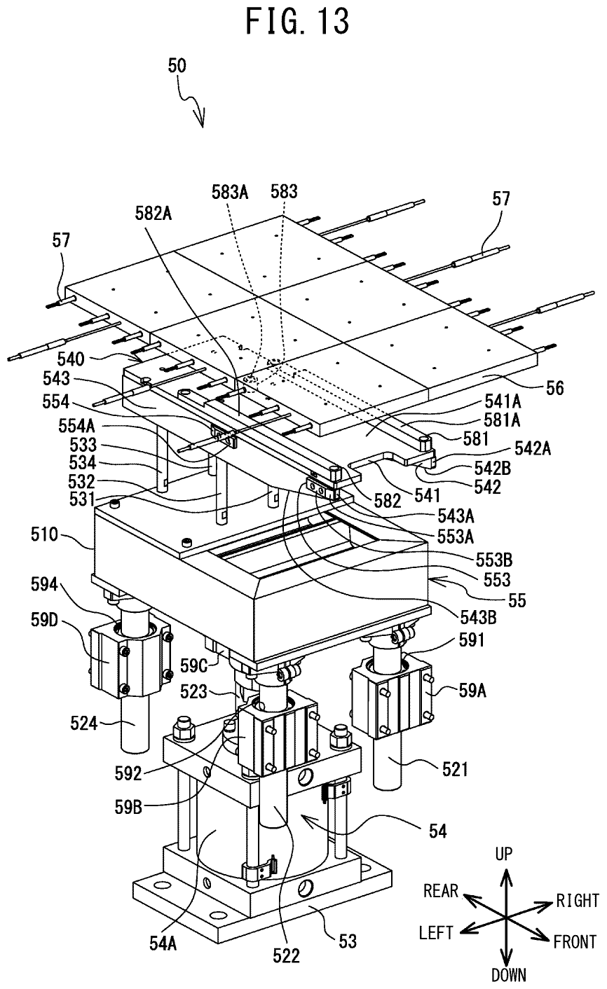

Hereinafter, a space defined by the right plate 41, the left plate 42, the upper plate 43, the connection plate 44, and the contact plate 45 will be referred to as an “insertion space 49”. The insertion space 49 penetrates the support pillar 40 in the front-rear direction. A mounting portion 23B of a printer 2 to be described later and shown in FIG. 8, or a press head 540 of a press machine 5 to be described later and shown in FIG. 13 is inserted into the insertion space 49. In the present embodiment, the mounting portion 23B being inserted into the insertion space 49, and the press head 540 being inserted into the insertion space 49 will also sometimes be referred to, respectively, as “the mounting portion 23B is inserted into the platen 10”, and “the press head 540 is inserted into the platen 10”.

As shown in FIG. 1 to FIG. 3, the tray 60 is disposed at a lowermost portion of the support base 12. The tray 60 receives a portion M1, of the print medium M placed on the placement surface 11A, that drops down from the placement surface 11A. In this way, the portion M1 that has dropped into the tray 60 is suppressed from coming into contact with a conveyance surface 70 of a conveyance device 7 to be described later and shown in FIG. 7. The tray 60 includes a bottom plate 61, a right plate 62, a left plate 63, a front plate 64, and a back plate 65.

As shown in FIG. 3, the bottom plate 61 extends in the front-rear direction and the left-right direction, and has a U shape that is open toward the rear in a bottom view. The lower surface of the bottom plate 61 is the lower surface of the tray 60. As shown in FIG. 2 and FIG. 3, a recess portion 61A is provided in the bottom plate 61. The recess portion 61A is recessed toward the front from the rear end of the bottom plate 61. As shown in FIG. 2, the right end of the recess portion 61A is connected to the lower end of the right plate 41. The left end of the recess portion 61A is connected to the lower end of the left plate 42. The front end of the recess portion 61A is connected to the lower end of the contact plate 45.

As shown in FIG. 4 and FIG. 5, the bottom plate 61 is disposed at the lower end of the platen 10. That is, the lower surface of the bottom plate 61 configures the lowermost surface of the support base 12. In other words, below the lower surface of the bottom plate 61, there are no components integrally configuring the support base 12.

As shown in FIG. 1, the right plate 62 extends upward from the right end of the bottom plate 61, and extends in the front-rear direction. The right plate 62 is disposed at the right end of the platen 10. The left plate 63 extends upward from the left end of the bottom plate 61, and extends in the front-rear direction. The left plate 63 is disposed at the left end of the platen 10. The front plate 64 extends upward from the front end of the bottom plate 61, and extends in the left-right direction. The front plate 64 is disposed at the front end of the platen 10.

As shown in FIG. 4, the upper ends of each of the right plate 62, and the left plate 63 and the front plate 64 shown in FIG. 5 are disposed, in the up-down direction, between the lower ends and the upper ends of each of the cutout portion 41C, and of the cutout portion 42C shown in FIG. 5.

As shown in FIG. 1 and FIG. 2, the back plate 65 extends upward from the rear end of the bottom plate 61, and extends in the left-right direction. The back plate 65 is disposed at the rear end of the platen 10. As shown in FIG. 2, a recess portion 65A is provided in the back plate 65. The recess portion 65A is recessed upward from the lower end of the back plate 65. The right end of the recess portion 65A is connected to the rear end of the right plate 41. The left end of the recess portion 65A is connected to the rear end of the left plate 42. The upper end of the recess portion 65A is connected to the rear end of the upper plate 43. The recess portion 65A configures the rear end of the insertion space 49.

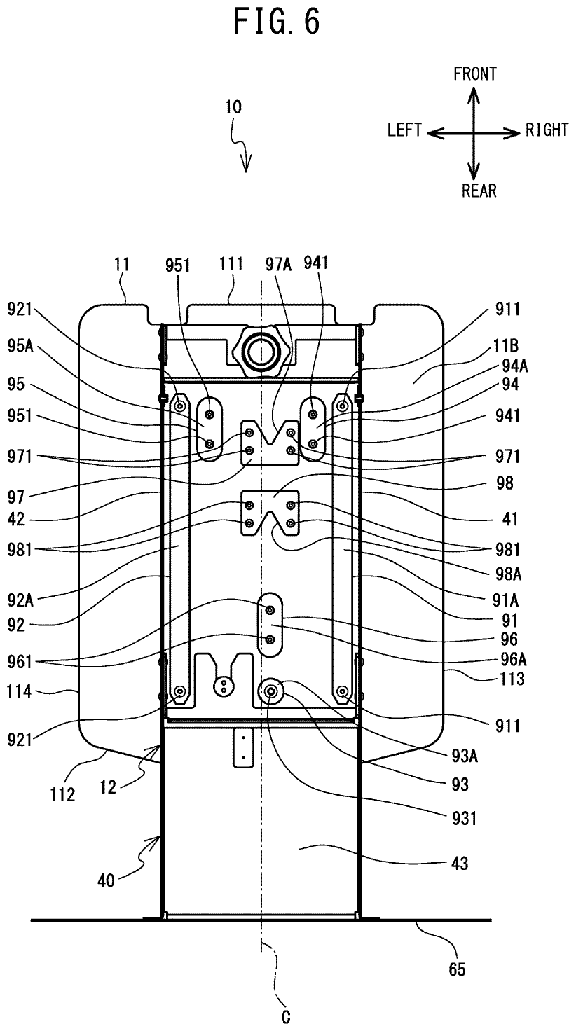

As shown in FIG. 3 and FIG. 6, the platen 10 is provided with a plurality of blocks 91, 92, 93, 94, 95, 96, 97, and 98. The plurality of blocks 91 to 98 are respectively provided on the lower surface 11B of the platen plate 11, and protrude downward from the lower surface 11B. Note that the block 91 being provided on the lower surface 11B of the platen plate 11 includes, for example, a case in which the block 91 is directly provided on the lower surface 11B of the platen plate 11, and a case in which the block 91 is provided on the lower surface 11B of the platen plate 11 via a spacer plate.

As shown in FIG. 6, the blocks 91 to 98 are respectively disposed at positions overlapping the platen plate 11 in the up-down direction. In other words, each of the blocks 91 to 98 is disposed within a region surrounded by the outer shape of the platen plate 11. Each of the blocks 91 to 98 is disposed between the right plate 41 and the left plate 42 in the left-right direction.

The block 91 is disposed between the right plate 41 and the center line C in the left-right direction. The block 91 that is hidden by the right plate 41 in FIG. 4 is indicated using a hidden line. As shown in FIG. 4, the block 91 extends in the front-rear direction between a position to the rear and in proximity to the perpendicular portion 41A and a position to the front and in proximity to the front end of the upper plate 43. As shown in FIG. 6, the block 91 is fixed to the lower surface 11B of the platen plate 11 by screws 911. The block 91 includes a press surface 91A. The press surface 91A is provided on the lower surface of the block 91. The press surface 91A has a flat surface shape and faces downward.

The block 92 is disposed between the left plate 42 and the center line C in the left-right direction. The block 92 extends in the front-rear direction between the rearward vicinity of the perpendicular portion 42A shown in FIG. 3 and the forward vicinity of the front end of the upper plate 43. The block 92 is fixed to the lower surface 11B of the platen plate 11 by screws 921. The block 92 includes a press surface 92A. The press surface 92A is provided on the lower surface of the block 92. The press surface 92A has a flat surface shape and faces downward.

The block 93 is disposed on the center line C at the rear portion of the platen plate 11. In the present embodiment, “a member is disposed on the center line C” does not refer only to a case in which the member is disposed such that the center line C passes through the center of the member, and also refers to a case in which the member is disposed such that the center line C passes through any position of the member. For example, the block 93 is disposed such that the center line C passes between the center of the block 93 in the left-right direction and the left end of the block 93. This also applies to the blocks 96, 97, and 98 to be described later.

The block 93 has a circular columnar shape extending in the up-down direction. The block 93 is fixed to the lower surface 11B of the platen plate 11 by a screw 931. The block 93 includes a press surface 93A. The press surface 93A is provided on the lower surface of the block 93. The press surface 93A has a flat surface shape and faces downward.

The block 94 is disposed at the front portion of the platen plate 11. The block 94 is disposed between the right plate 41 and the center line C in the left-right direction, and is disposed further to the left than the block 91. The block 94 extends to the rear from substantially the same position as the front end of the block 91 in the front-rear direction. The length of the block 94 in the front-rear direction is shorter than the length of the block 91 in the front-rear direction, and is approximately ¼ the length of the block 91 in the front-rear direction. The block 94 is fixed to the lower surface 11B of the platen plate 11 by screws 941. The block 94 includes a support surface 94A. The support surface 94A is provided on the lower surface of the block 94. The support surface 94A has a flat surface shape and faces downward.

The block 95 is disposed at the front portion of the platen plate 11. The block 95 is disposed between the left plate 42 and the center line C in the left-right direction, and is disposed further to the right than the block 92. The block 95 extends to the rear from substantially the same position as the front end of the block 92 in the front-rear direction. The length of the block 95 in the front-rear direction is shorter than the length of the block 92 in the front-rear direction, and is approximately ¼ the length of the block 92 in the front-rear direction. The block 95 is fixed to the lower surface 11B of the platen plate 11 by screws 951. The block 95 includes a support surface 95A. The support surface 95A is provided on the lower surface of the block 95. The support surface 95A has a flat surface shape and faces downward.

The block 96 is disposed at the rear portion of the platen plate 11, on the center line C. The block 96 is disposed further to the rear than each of the blocks 94 and 95, and is disposed further to the front than the block 93. The block 96 extends in the front-rear direction. The length of the block 96 in the front-rear direction is shorter than the length of the blocks 91 and 92 in the front-rear direction, and is approximately ¼ the length of the blocks 91 and 92 in the front-rear direction. The block 96 is fixed to the lower surface 11B of the platen plate 11 by screws 961. The block 96 includes a support surface 96A. The support surface 96A is provided on the lower surface of the block 96. The support surface 96A has a flat surface shape and faces downward.

The block 97 is disposed at the front portion of the platen plate 11, on the center line C. A recess portion 97A is provided in the block 97. The recess portion 97A is recessed to the rear from the front surface of the block 97, and includes a pair of opposing surfaces. The pair of opposing surfaces of the recess portion 97A face each other in the left-right direction, and widen outward in the left-right direction the further toward the front. The block 97 is fixed to the lower surface 11B of the platen plate 11 by screws 971.

The block 98 is disposed at the center portion of the platen plate 11, on the center line C. The block 98 is disposed between the block 97 and the block 96 in the front-rear direction. A recess portion 98A is provided in the block 98. The recess portion 98A is recessed toward the front from the rear surface of the block 98, and includes a pair of opposing surfaces. The pair of opposing surfaces of the recess portion 98A face each other in the left-right direction and widen outward in the left-right direction the further toward the rear. The block 98 is fixed to the lower surface 11B of the platen plate 11 by screws 981.

As described above, the press surfaces 91A, 92A, and 93A are provided between the right plate 41 and the left plate 42 in the left-right direction. The press surfaces 91A and 92A are provided at positions where the support surfaces 94A, 95A, and 96A are interposed therebetween. The press surface 91A is provided at a different position from each of the support surfaces 94A, 95A, and 96A in the left-right direction and the front-rear direction. In a similar manner, the press surfaces 92A and 93A are also provided at different positions from each of the support surfaces 94A, 95A, and 96A in the left-right direction and the front-rear direction. The center line C passes through the press surface 93A, the support surface 96A, and the recess portions 97A and 98A in the order of the press surface 93A, the support surface 96A, and the recess portions 98A and 97A from the rear toward the front.

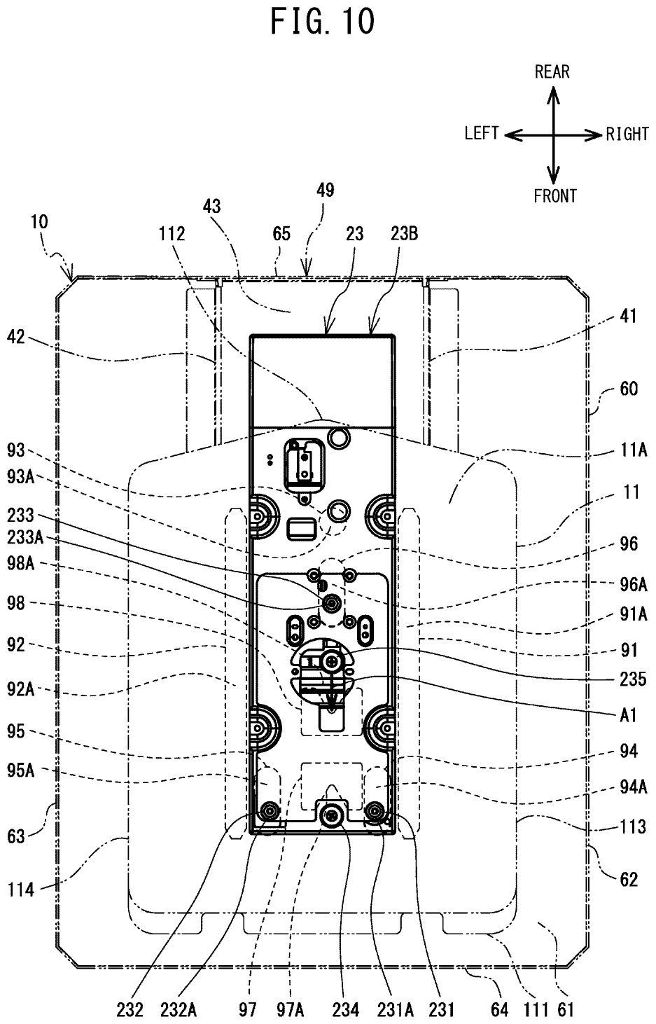

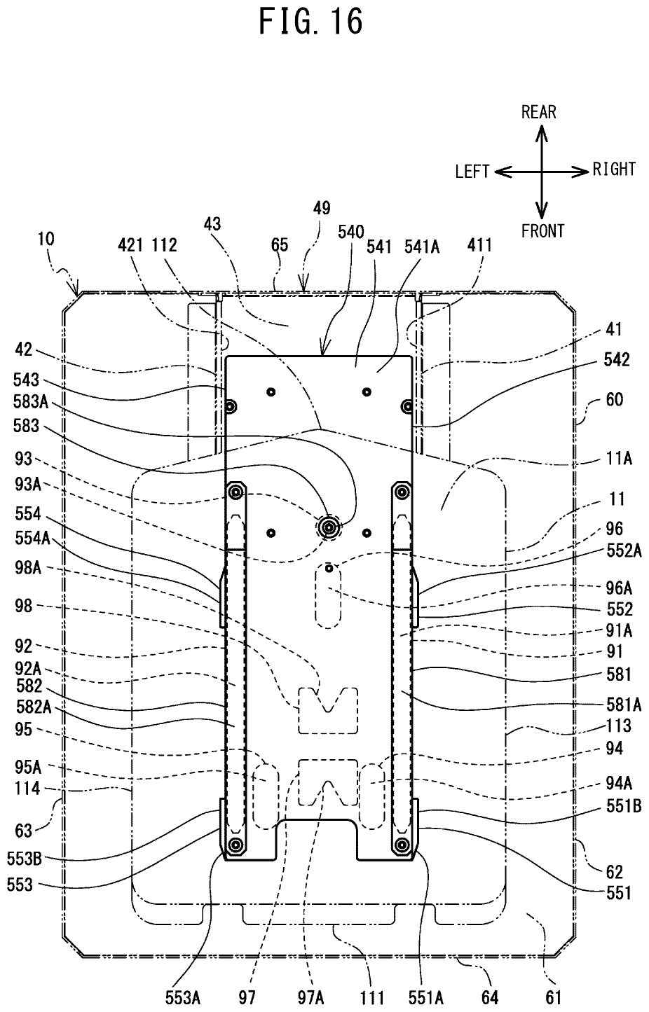

Press surfaces 581A, 582A, and 583A of the press head 540, to be described later and shown in FIG. 16, respectively come into contact with the press surfaces 91A, 92A, and 93A when the press head 540 performs a pressing operation, to be described later, in a state in which the platen 10 is set on the press head 540. Support surfaces 231A, 232A, and 233A of the mounting portion 23B, to be described later and shown in FIG. 10, respectively come into contact with the support surfaces 94A, 95A, and 96A in a state in which the platen 10 is mounted to the mounting portion 23B. Protrusions 234 and 235 of the mounting portion 23B are respectively fitted into the recess portions 97A and 98A in the state in which the platen 10 is mounted to the mounting portion 23B shown in FIG. 10.

For example, when the screws 911 are removed, the block 91 is removed from the platen plate 11. Thus, the block 91 can be replaced on the platen plate 11. In a similar manner, the blocks 92 to 98 can be replaced on the platen plate 11. A user may replace the block 91, for example, when the block 91 is worn as a result of the pressing operation to be described later.

As shown in FIG. 5, the support surfaces 94A and 95A are positioned at the same height in the up-down direction. In a similar manner, the support surface 96A shown in FIG. 6 is also positioned at the same height as the support surfaces 94A and 95A in the up-down direction. In other words, the support surfaces 94A, 95A, and 96A are positioned on the same plane.

The press surfaces 91A and 92A are positioned at the same height in the up-down direction. In a similar manner, the press surface 93A shown in FIG. 6 is also positioned at the same height as the press surfaces 91A and 92A in the up-down direction. In other words, the press surfaces 91A, 92A, and 93A are positioned on the same plane.

The press surfaces 91A and 92A are positioned higher than the lower surface of the bottom plate 61, namely, higher than the lowermost surface of the support base 12. In a similar manner, the press surface 93A shown in FIG. 6 is also positioned higher than the lower surface of the bottom plate 61, namely, higher than the lowermost surface of the support base 12. In the present embodiment, the press surfaces 91A, 92A, and 93A are positioned higher than the upper surface of the connection plate 44.

The press surfaces 91A and 92A are positioned lower than the support surfaces 94A, 95A, and 96A in the up-down direction. In a similar manner, the press surface 93A shown in FIG. 6 is also positioned lower than the support surfaces 94A, 95A, and 96A in the up-down direction. In other words, the press surfaces 91A, 92A, and 93A are positioned on a plane that is different from that of the support surfaces 94A, 95A, and 96A in the up-down direction.

As shown in FIG. 4 and FIG. 5, the press surface 91A is parallel to the placement surface 11A. As shown in FIG. 5, the press surface 92A is parallel to the placement surface 11A. In a similar manner, the press surface 93A shown in FIG. 6 is also parallel to the placement surface 11A. The support surfaces 94A and 95A are parallel to the placement surface 11A. In a similar manner, the support surface 96A shown in FIG. 6 is also parallel to the placement surface 11A.

The print system 1 will be described with reference to FIG. 7. In the description of the print system 1, the upward direction, the downward direction, the left direction, the right direction, the depth direction on paper, and the front direction on paper in FIG. 7, are, respectively, the rear direction, the front direction, the left direction, the right direction, the downward direction, and the upward direction of the print system 1. The print system 1 is a system that, while conveying the plurality of platens 10, sequentially executes application processing, surface processing, and print processing, in the order of the application processing, the surface processing and the print processing, on the print media M set on each of the plurality of platens 10. Each of the processing will be described in detail later.

The print system 1 is provided with the platens 10, the printer 2, an application device 3, the press machine 5, and the conveyance device 7. In order to simplify the description, the description is made on the basis that the number of each of the printer 2, the application device 3, and the press machine 5 is one, but the number of each may be a plurality thereof. The printer 2, the application device 3, and the press machine 5 are aligned in order of the application device 3, the press machine 5, and the printer 2 from the front toward the rear.

The printer 2 is a device that performs the print processing, and, in the present embodiment, is an inkjet printer. The print processing is processing for applying liquid ink to the print medium M and printing an image. A detailed structure of the printer 2 will be described later.

The application device 3 is a device that performs the application processing. The application processing is performed in advance of the print processing. The application processing is processing for applying a treatment liquid to the print medium M. The treatment liquid is a base coat agent, and is an aqueous solution containing a cationic polymer or a polyvalent metal salt, for example. The polyvalent metal salt is calcium chloride or calcium nitrite, for example. The treatment liquid improves fixing of the ink to the print medium M and improves color development of the ink.

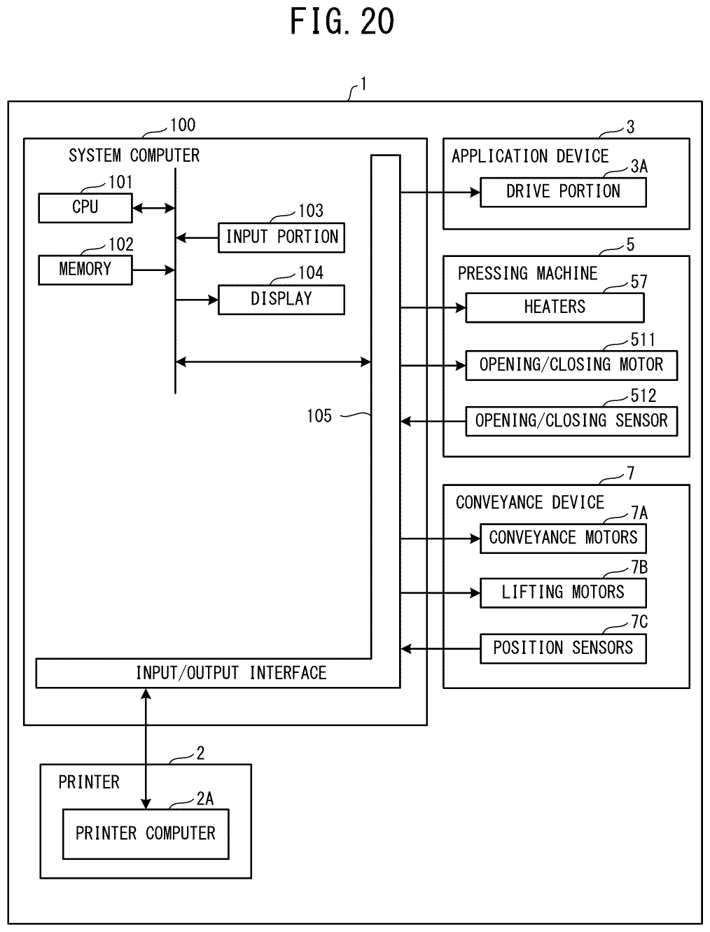

The application device 3 is provided with an application portion 31. The application portion 31 is a spray in the present embodiment, and sprays the treatment liquid as a result of driving of a drive portion 3A shown in FIG. 20. The drive portion 3A is configured by a compressor and a solenoid valve, for example. Note that the application portion 31 may be an ejection head, an application spatula, or the like.

In the application device 3, in a state in which the platen 10 is disposed directly below the application portion 31, the application portion 31 sprays the treatment liquid onto the print medium M on the platen plate 11. In this way, the application processing is performed in which the treatment liquid is applied to the print medium M.

The press machine 5 is a device that performs the surface processing. The surface processing is performed subsequent to the application processing and in advance of the print processing. As a result of the press machine 5 performing the surface processing, the print quality of the print medium M is improved. The surface processing causes a state of the surface of the print medium M to be even. For example, the surface processing evens out irregularities in the surface of the print medium M to a flat surface shape. When the print medium M is cloth, for example, in the surface processing, the press machine 5 evens out the irregularities in the surface of the print medium M to the flat surface shape by smoothing down the nap of the print medium M.

Furthermore, in the present embodiment, the surface processing includes heat press processing. The heat press processing is processing for evaporating the moisture content in the treatment liquid, by applying pressure to the print medium M at a high temperature. In this way, fixing of solute in the treatment liquid to the print medium M is improved. A detailed structure of the press machine 5 will be described later.

For example, drying processing by a dryer (not shown in the drawings) may be performed in advance of the surface processing. The drying processing causes the moisture in the treatment liquid applied to the print medium M by the application processing to evaporate, by drying the print medium M in a high-temperature atmosphere.

The conveyance device 7 configures conveyance paths of the platen 10, and conveys the platen 10 such that the application processing, the surface processing, and the print processing are sequentially performed. In a state in which the platen 10 is supported by the conveyance device 7, the conveyance device 7 is disposed below the lowermost surface of the support base 12 shown in FIG. 1. A conveyance surface 70 is formed at the upper surface of the conveyance device 7. The conveyance surface 70 is positioned at the upper end of the conveyance device 7, and faces upward. In the state in which the platen 10 is supported by the conveyance device 7, the conveyance surface 70 is in contact with the lowermost surface of the support base 12, and with the lower surface of the tray 60 in the present embodiment. In other words, in the state in which the platen 10 is supported by the conveyance device 7, the tray 60 is disposed above the conveyance surface 70.

The conveyance device 7 is provided with a main path 71, transfer mechanisms 83 to 85, and branched paths 87 and 88. The main path 71 has a two-level structure, and is provided with an outward path 72, a return path (not shown in the drawings), and elevator mechanisms 74 and 75.

The outward path 72 is a second level portion, and is disposed further to the left than each of the printer 2, the application device 3, and the press machine 5. The outward path 72 extends in the front-rear direction from a position further to the front than the application device 3 to a position further to the rear than the printer 2. The return path is a first level portion, and extends in the front-rear direction from a position further to the front than the application device 3 to a position further to the rear than the printer 2. In other words, the return path is disposed directly below the outward path 72, and extends in parallel to the outward path 72.

The outward path 72 conveys the platen 10 from the front toward the rear by driving of a conveyance motor 7A, of the outward path 72, shown in FIG. 20. In the present embodiment, the outward path 72 is configured by a pair of belt conveyors 721 and 722. The belt conveyor 721 is disposed at the left end of the outward path 72. The belt conveyor 722 is disposed at the right end of the outward path 72. The pair of belt conveyors 721 and 722 extend in the front-rear direction in parallel to each other. Rotation shafts of each the pair of belt conveyors 721 and 722 extend in the left-right direction. The upper ends of each of the pair of belt conveyors 721 and 722 configure the conveyance surface 70. The return path has the same structure as that of the outward path 72. The return path conveys the platen 10 from the rear toward the front by driving of the conveyance motor 7A, of the return path, shown in FIG. 20.

The elevator mechanism 74 is disposed at the front end of the main path 71. The elevator mechanism 75 is disposed at the rear end of the main path 71. Thus, the outward path 72 and the return path are positioned between the elevator mechanism 74 and the elevator mechanism 75 in the front-rear direction. The elevator mechanisms 74 and 75 are respectively driven by a lifting motor 7B shown in FIG. 20, and thus move up and down between a position at the same height as the outward path 72 (the second level portion) and a position at the same height as the return path (the first level portion). Furthermore, the elevator mechanisms 74 and 75 convey the platen 10 in the front-rear direction by the driving of each of the conveyance motors 7A shown in FIG. 20.

In the present embodiment, the elevator mechanism 74 is configured by a pair of belt conveyors 741 and 742. The belt conveyor 741 is disposed at the left end of the elevator mechanism 74. The belt conveyor 742 is disposed at the right end of the elevator mechanism 74. The pair of belt conveyors 741 and 742 extend in the front-rear direction in parallel to each other. Rotation shafts of each the pair of belt conveyors 741 and 742 extend in the left-right direction. The upper ends of each of the pair of belt conveyors 741 and 742 configure the conveyance surface 70. The elevator mechanism 75 has the same structure as that of the elevator mechanism 74. Thus, a description of the structure of the elevator mechanism 75 is omitted here.

The transfer mechanisms 83 to 85 are disposed between the pair of belt conveyors 721 and 722 in the left-right direction. The transfer mechanisms 83 to 85 are aligned in order of the transfer mechanisms 83, 84, and 85 from the front to the rear, on the outward path 72. Each of the transfer mechanisms 83 to 85 conveys the platen 10 in the left-right direction. The transfer mechanism 83 transfers the platen 10 between the outward path 72 and the branched path 87 to be described later. The transfer mechanism 84 transfers the platen 10 between the outward path 72 and the branched path 88 to be described later. The transfer mechanism 85 transfers the platen 10 between the outward path 72 and a conveyance support base 23 of the printer 2 to be described later.

The transfer mechanisms 83 and 85 each has the same structure as that of the transfer mechanism 84. Thus, hereinafter, the structure of the transfer mechanism 84 will be described, and a description of the structure of the transfer mechanisms 83 and 85 will be omitted. In the present embodiment, by driving of the lifting motor 7B of the transfer mechanism 84 shown in FIG. 20, the transfer mechanism 84 moves up and down between a position lower than the outward path 72 and a position higher than the outward path 72. Furthermore, by driving of a rotation motor (not shown in the drawings), the transfer mechanism 84 rotates the platen 10 on the transfer mechanism 84 in the clockwise direction or the counterclockwise direction in a plan view. The transfer mechanism 84 switches an orientation of the platen 10 such that the rear of the platen 10, that is, the rear surface of the back plate 65, is oriented in an advancing direction of the platen 10.

In the present embodiment, the transfer mechanism 84 is configured by a pair of belt conveyors 841 and 842. The belt conveyor 841 is disposed at the front end of the transfer mechanism 84. The belt conveyor 842 is disposed at the rear end of the transfer mechanism 84. The pair of belt conveyors 841 and 842 extend in the left-right direction in parallel to each other. Rotation shafts of each of the pair of belt conveyors 841 and 842 extend in the front-rear direction. The upper ends of each of the pair of belt conveyors 841 and 842 configure the conveyance surface 70.

The branched path 87 is disposed to the right and adjacent to the transfer mechanism 83, and branches to the right from the main path 71. The branched path 87 is disposed inside the application device 3. The branched path 88 is disposed to the right and adjacent to the transfer mechanism 84, and branches to the right from the main path 71. The branched path 88 is disposed inside the press machine 5. Each of the branched paths 87 and 88 conveys the platen 10 in the left-right direction.

The branched path 87 has the same structure as that of the branched path 88. Thus, hereinafter, the structure of the branched path 88 will be described and a description of the structure of the branched path 87 will be omitted. In the present embodiment, the branched path 88 is configured by a pair of belt conveyors 881 and 882. The belt conveyor 881 is disposed at the front end of the branched path 88. The belt conveyor 882 is disposed at the rear end of the branched path 88. The pair of belt conveyors 881 and 882 extend in the left-right direction in parallel to each other. Rotation shafts of each of the pair of belt conveyors 881 and 882 extend in the front-rear direction. The upper ends of each of the pair of belt conveyors 881 and 882 configure the conveyance surface 70.

A flow of operations of the print system 1 will be described. Hereinafter, for convenience, at a start of the operations of the print system 1, it is assumed that each of the transfer mechanisms 83 to 85 is disposed lower than the outward path 72, and each of the elevator mechanisms 74 and 75 is disposed at the same height as the outward path 72.

In the present embodiment, in a state in which the platen 10 is disposed on the elevator mechanism 74, the rear of the platen 10 shown in FIG. 1, namely, the rear surface of the back plate 65, is oriented to the rear of the print system 1. Note that, in the state in which the platen 10 is disposed on the elevator mechanism 74, the rear of the platen 10 may be oriented to the front of the print system 1, or may be oriented to the left or the right. The user sets the print medium M on the platen 10 in the state in which the platen 10 is disposed on the elevator mechanism 74. The elevator mechanism 74 conveys the platen 10 to the rear, and transfers the platen 10 to the outward path 72.

The outward path 72 conveys the platen 10 to the rear to the transfer mechanism 83. The transfer mechanism 83 moves up to a position higher than the outward path 72. In this way, the platen 10 is transferred from the outward path 72 to the transfer mechanism 83. The transfer mechanism 83 rotates the platen 10 by 90° in the clockwise direction in a plan view, and conveys the platen 10 to the right to the branched path 87. The transfer mechanism 83 moves down to a position less than the branched path 87. In this way, the platen 10 is transferred from the transfer mechanism 83 to the branched path 87. The application device 3 performs the application processing.

When the application processing by the application device 3 is complete, the branched path 87 conveys the platen 10 to the left to the transfer mechanism 83. The transfer mechanism 83 moves up to a position higher than the branched path 87. In this way, the platen 10 is transferred from the branched path 87 to the transfer mechanism 83. The transfer mechanism 83 rotates the platen 10 by 90° in the counterclockwise direction in a plan view, and moves down to a position less than the outward path 72. In this way the platen 10 is transferred from the transfer mechanism 83 to the outward path 72.

A mode of transfer of the platen 10 by each of the transfer mechanisms 84 and 85 is the same as the mode of transfer of the platen 10 by the transfer mechanism 83. Thus, hereinafter, a description of the transfer of the platen 10 by each of the transfer mechanisms 84 and 85 will be omitted or simplified.

The outward path 72 conveys the platen 10 to the rear and transfers the platen 10 to the transfer mechanism 84. The transfer mechanism 84 conveys the platen 10 to the right, and transfers the platen 10 to the branched path 88. The press machine 5 performs the surface processing. When the surface processing by the press machine 5 is complete, the branched path 88 conveys the platen 10 to the left, and transfers the platen 10 to the transfer mechanism 84. The transfer mechanism 84 transfers the platen 10 to the outward path 72.

The outward path 72 conveys the platen 10 to the rear, to the transfer mechanism 85. The platen 10 is transferred from the outward path 72 to the transfer mechanism 85. The transfer mechanism 85 conveys the platen 10 to the right, and transfers the platen 10 to the conveyance support base 23 to be described later. The printer 2 performs the print processing. When the print processing by the printer 2 is complete, the conveyance support base 23 conveys the platen 10 to the left, and transfers the platen 10 to the transfer mechanism 85. The transfer mechanism 85 transfers the platen 10 to the outward path 72.

The outward path 72 conveys the platen 10 to the rear and transfers the platen 10 to the elevator mechanism 75. The elevator mechanism 75 moves down to the same height as the return path (not shown in the drawings). The elevator mechanism 75 conveys the platen 10 to the front and transfers the platen 10 to the return path. The return path conveys the platen 10 to the front in a state in which the elevator mechanism 74 is at the same height as the return path, and transfers the platen 10 to the elevator mechanism 74.

The user removes the print medium M on which the image has been printed from the platen 10, during a period in which the platen 10 is being conveyed from the elevator mechanism 75 to the elevator mechanism 74 via the return path. For example, the user removes the print medium M on which the image has been printed from the platen 10 in a state in which the platen 10 is disposed on the elevator mechanism 75. Subsequently, the user sets the next print medium M on the platen 10 in the state in which the platen 10 is disposed on the elevator mechanism 74. The same operations by the print system 1 are subsequently repeated.

The detailed structure of the printer 2 will be described with reference to FIG. 8 to FIG. 10. In the description of the printer 2, the lower left direction, the upper right direction, the lower right direction, the upper left direction, the upward direction, and the downward direction in FIG. 8, are, respectively, the left direction, the right direction, the front direction, the rear direction, the upward direction, and the downward direction of the printer 2. The front of the printer 2 shown in FIG. 8 is the left direction of the print system 1 shown in FIG. 7.

As shown in FIG. 8 and FIG. 9, the printer 2 is provided with a frame body 21, a shaft 22, the conveyance support base 23, guide rails 24A and 24B, a carriage 25, and a plurality of inkjet heads 26. The frame body 21 is configured in a lattice shape by a plurality of shafts. A platen opening 21A is formed in the frame body 21. The platen opening 21A extends to the rear from a center portion of the front surface of the frame body 21.

The shaft 22 is disposed at a lower portion of the platen opening 21A, and extends in the front-rear direction. The shaft 22 supports the conveyance support base 23. The conveyance support base 23 is disposed inside the platen opening 21A in a front view. The conveyance support base 23 moves in the front-rear direction along the shaft 22 between a separated position P1 and a print position P2, shown in FIG. 9 and to be described later, by driving of a sub-scanning motor (not shown in the drawings).

The conveyance support base 23 includes a base portion 23A and a mounting portion 23B. The base portion 23A has a cuboid shape, and extends in the up-down direction. The lower end of the base portion 23A is coupled to the shaft 22. The mounting portion 23B has a cuboid shape, and extends to the front from the upper end of the base portion 23A. The platen 10 can be mounted to and detached from the mounting portion 23B. FIG. 8 shows a state in which the platen 10 is not mounted to the mounting portion 23B. FIG. 9 and FIG. 10 show a state in which the platen 10 is mounted to the mounting portion 23B. In the state in which the platen 10 is mounted to the mounting portion 23B, the mounting portion 23B supports the platen 10.

As shown in FIG. 8 and FIG. 10, the mounting portion 23B includes protrusions 231, 232, 233, 234, and 235. The protrusion 231 is disposed at a front right corner of the upper surface of the mounting portion 23B. The protrusion 231 has a circular column shape, and protrudes upward from the upper surface of the mounting portion 23B. A support surface 231A is provided on the upper surface of the protrusion 231. The support surface 231A has a flat surface shape and faces upward.

The protrusion 232 is disposed at a front left corner of the upper surface of the mounting portion 23B. The protrusion 232 has a circular column shape, and protrudes upward from the upper surface of the mounting portion 23B. A support surface 232A is provided on the upper surface of the protrusion 232. The support surface 232A has a flat surface shape and faces upward. The protrusion 233 is disposed at a center portion of the upper surface of the mounting portion 23B. The protrusion 233 has a circular column shape, and protrudes upward from the upper surface of the mounting portion 23B. A support surface 233A is provided on the upper surface of the protrusion 233. The support surface 233A has a flat surface shape and faces upward.

The protrusion 234 is disposed at the front end of the upper surface of the mounting portion 23B, and is disposed between the protrusions 231 and 232 in the left-right direction. The protrusion 234 has a circular column shape, and protrudes upward from the upper surface of the mounting portion 23B. The protrusion 235 is disposed at a center portion of the upper surface of the mounting portion 23B in the left-right direction, and is disposed between the protrusions 233 and 234 in the front-rear direction. The protrusion 235 has a circular column shape, and protrudes upward from the upper surface of the mounting portion 23B. The protrusion 235 is supported by the mounting portion 23B so as to be able to move in the front-rear direction.

The guide rail 24A is provided at the upper portion of the platen opening 21A, and is fixed to the frame body 21. The guide rail 24A extends in the left-right direction. The guide rail 24B is provided to the rear of the guide rail 24A. The guide rail 24B is provided at the upper portion of the platen opening 21A, and is fixed to the frame body 21. The guide rail 24B extends in the left-right direction.

The carriage 25 is positioned between the guide rails 24A and 24B in the front-rear direction. The carriage 25 is a plate, and extends in the front-rear direction and the left-right direction. The carriage 25 is supported by the guide rails 24A and 24B. The carriage 25 is driven by a main scanning motor (not shown in the drawings), and moves in the left-right direction along the guide rails 24A and 24B.

The plurality of inkjet heads 26 are mounted to the carriage 25, and are aligned next to each other in the front-rear direction. The plurality of inkjet heads 26 move in the left-right direction together with the carriage 25. Hereinafter, of a movement region of the plurality of inkjet heads 26 in a plan view, a region overlapping a movement region of the platen 10 mounted to the mounting portion 23B will be referred to as a “print region R”.

As shown in FIG. 9, nozzle surfaces 26A are formed at the lower surfaces of the inkjet heads 26. The nozzle surface 26A is exposed downward from an opening (not shown in the drawings) provided in the carriage 25. A plurality of nozzles (not shown in the drawings) are provided in the nozzle surface 26A.

The plurality of inkjet heads 26 discharge ink downward from the nozzles. For example, the plurality of inkjet heads 26 include heads that discharge color inks (cyan, magenta, yellow, or black). The color inks are used for printing a color image. The plurality of inkjet heads 26 may also include a head that discharges white ink, and may include a head that discharges a pre-treatment liquid or a post-treatment liquid. The white ink is used as a base coat for the color image to be printed, or is used for the printing of the color image. A number of the plurality of inkjet heads 26 is not limited to a particular number, and may be one, for example.

The mounting of the platen 10 to the mounting portion 23B and the printing by the printer 2 will be described. As shown in FIG. 8, the platen 10 is conveyed by the transfer mechanism 85 from the front to the rear toward the mounting portion 23B, in a posture in which the rear of the platen 10 is oriented to the rear of the printer 2. When the platen 10 is conveyed to the mounting portion 23B, the mounting portion 23B is inserted into the insertion space 49.

A conveyance direction of the platen 10 when the mounting portion 23B is inserted into the platen 10 is the direction from the front toward the rear. In other words, the front of the platen 10 is upstream in the conveyance direction of the platen 10 when the mounting portion 23B is inserted into the platen 10, and the rear of the platen 10 is downstream in the conveyance direction of the platen 10 when the mounting portion 23B is inserted into the platen 10.

FIG. 10 shows the mounting portion 23B using solid lines, and shows the platen 10 using virtual lines. In FIG. 10, in the platen 10, the blocks 91 to 98 hidden by the platen plate 11 are shown using hidden lines. As shown in FIG. 10, in the state in which the mounting portion 23B is inserted into the platen 10, the support surface 94A faces the support surface 231A from above with an interval therebetween, the support surface 95A faces the support surface 232A from above with an interval therebetween, and the support surface 96A faces the support surface 233A from above with an interval therebetween. When the transfer mechanism 85 moves down in this state, the support surface 94A comes into contact with the support surface 231A from above, the support surface 95A comes into contact with the support surface 232A from above, and the support surface 96A comes into contact with the support surface 233A from above. In this way, the mounting portion 23B supports the platen 10, and the position of the platen 10 with respect to the mounting portion 23B in the up-down direction is determined.

Furthermore, the block 97 is disposed to the rear of the protrusion 234 and the block 98 is disposed to the front of the protrusion 235. In this state, when the protrusion 235 is urged to the front by an urging member (not shown in the drawings), the protrusion 235 moves forward with respect to the protrusion 234, as shown by an arrow A1, and fits into the recess portion 98A. When the protrusion 235 moves further to the front, this causes the platen 10 to move to the front. The protrusion 235 moves the platen 10 to the front until the protrusion 234 fits into the recess portion 97A. The protrusion 235 presses the block 97 against a protrusion 234, via the block 98. In this way, the position of the platen 10 is determined with respect to the mounting portion 23B in the front-rear direction and the left-right direction, and the platen 10 is mounted to the mounting portion 23B.

In the present embodiment, in the state in which the platen 10 is mounted to the mounting portion 23B, the press surfaces 91A, 92A, and 93A are disposed at positions separated upward from the upper surface of the mounting portion 23B. Furthermore, the press surface 91A is disposed further to the right than the right end of the mounting portion 23B, and the press surface 92A is disposed further to the left than the left end of the mounting portion 23B. Thus, the press surfaces 91A, 92A, and 93A do not touch the mounting portion 23B.

As shown in FIG. 9, the conveyance support base 23 conveys the platen 10 to the separated position P1 and the print position P2. FIG. 9 shows the platen 10 mounted to the mounting portion 23B and disposed at the separated position P1 using virtual lines, and shows the platen 10 mounted to the mounting portion 23B and disposed at the print position P2 using solid lines.

When the platen 10 is disposed at the separated position P1, the placement surface 11A is separated from the plurality of inkjet heads 26 to one side in a sub-scanning direction, and is separated to the front in the present embodiment. When the platen 10 is disposed at the print position P2, the platen 10 is disposed in the print region R. Thus, when the platen 10 is disposed at the print position P2 in a state in which the plurality of inkjet heads 26 are disposed in the print region R, the placement surface 11A faces the plurality of inkjet heads 26 in the up-down direction. More specifically, when the platen 10 is disposed at the print position P2, the placement surface 11A faces at least one of the nozzle surfaces 26A of the plurality of inkjet heads 26 from below.

An operation in which, while the carriage 25 conveys the plurality of inkjet heads 26 in the left-right direction, one or more of the plurality of inkjet heads 26 discharge the ink from the nozzles, will be referred to as a “main scan”. An operation in which the conveyance support base 23 conveys the platen 10 by a predetermined amount in the front-rear direction will be referred to as a “sub-scan”. The printer 2 performs the printing on the print medium M by repeating the main scan and the sub-scan in the state in which the plurality of inkjet heads 26 are positioned in the print region R and the platen 10 is positioned at the print position P2. In this case, the ink discharged from each of the plurality of inkjet heads 26 by the main scan lands on the print medium M on the platen plate 11, and forms the image on the print medium M.

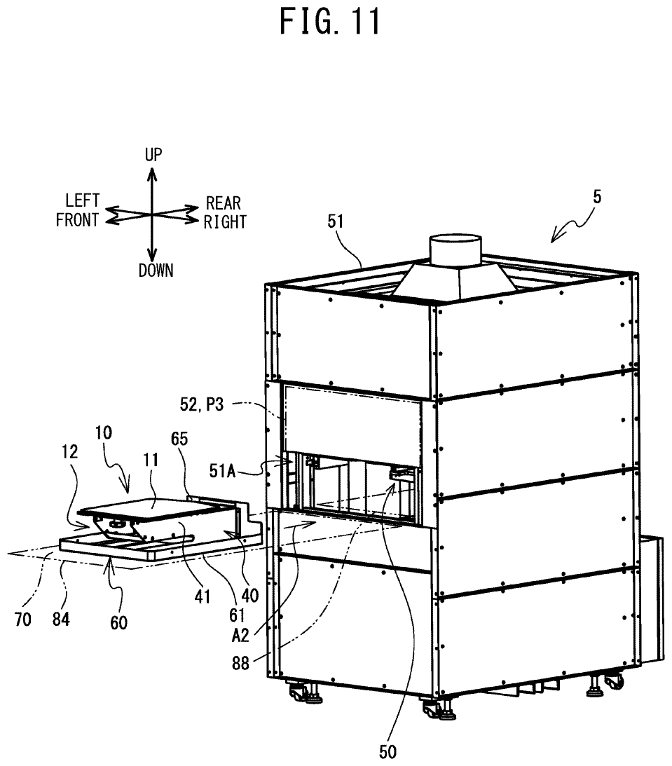

The detailed structure of the press machine 5 will be described with reference to FIG. 11 to FIG. 19. In the description of the press machine 5, the upper left direction, the lower right direction, the lower left direction, the upper right direction, the upward direction, and the downward direction in FIG. 11 are, respectively, the left direction, the right direction, the front direction, the rear direction, the upward direction, and the downward direction of the press machine 5. The front direction of the press machine 5 shown in FIG. 11 is the left direction of the print system 1 shown in FIG. 7.

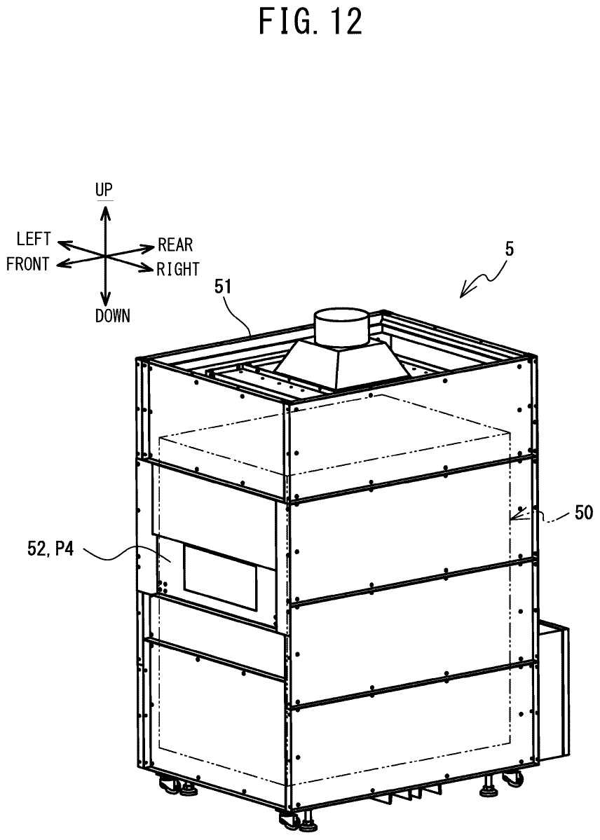

As shown in FIG. 11 and FIG. 12, the press machine 5 is provided with a housing 51, a shutter 52, and a device main body 50 shown in FIG. 12. The housing 51 has a cuboid box shape, and covers the device main body 50. An opening 51A shown in FIG. 11 is provided in the front surface of the housing 51. The opening 51A is larger than the outer contour of the platen 10 in a front view, and, in the present embodiment, has a rectangular shape. The platen 10 enters into and emerges from the housing 51 via the opening 51A.

The shutter 52 is a plate, and is provided at the front surface of the housing 51. The shutter 52 is supported by the housing 51 so as to be able to move in the up-down direction. The shutter 52 moves to an open position P3 shown in FIG. 11 and to a closed position P4 shown in FIG. 12 as a result of being driven by an opening/closing motor 511 shown in FIG. 20. As shown in FIG. 11, the shutter 52 is disposed above the opening 51A at the open position P3, and opens the opening 51A. In this case, the platen 10 can enter into and emerge from the housing 51 via the opening 51A. As shown in FIG. 12, the shutter 52 blocks the opening 51A at the closed position P4. In this case, the platen 10 cannot enter into or emerge from the housing 51 via the opening 51A.

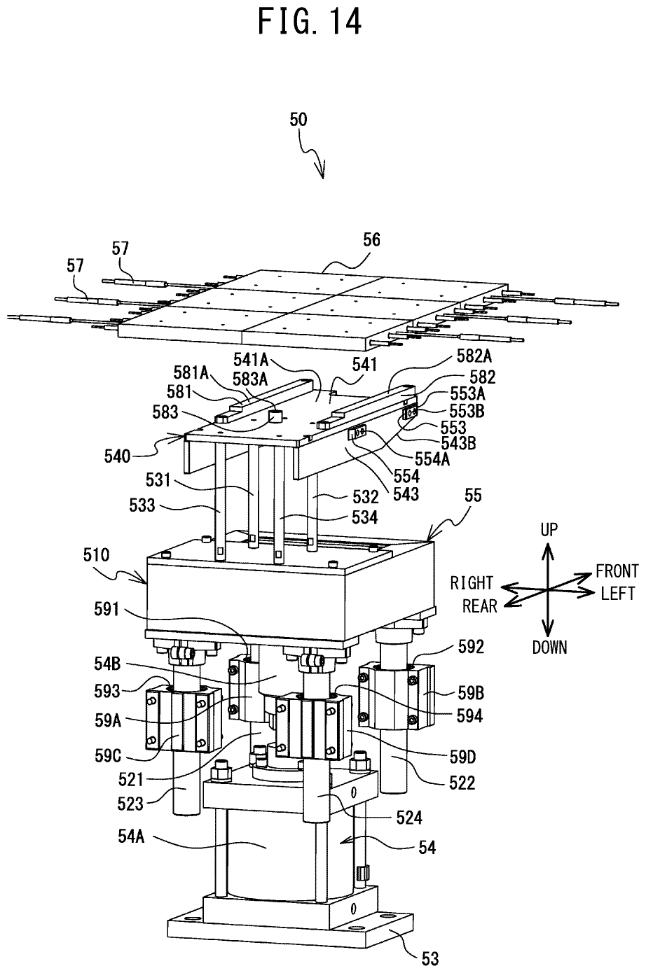

As shown in FIG. 13 and FIG. 14, the device main body 50 is provided with a base 53, a cylinder 54, a moving portion 55, a fixed plate 56, and heaters 57. The base 53 has a plate shape, and is disposed at the lower end of the device main body 50. The cylinder 54 is an air cylinder, and includes a cylinder body 54A and a cylinder rod 54B shown in FIG. 14. The cylinder body 54A has a tubular shape, and is fixed to the upper surface of the base 53. The cylinder rod 54B extends in the up-down direction, and protrudes upward from the upper surface of the cylinder body 54A. The cylinder rod 54B is supported by the cylinder body 54A so as to be able to move in the up-down direction.

The moving portion 55 is disposed above the cylinder 54, and moves in the up-down direction as a result of the up and down movement of the cylinder rod 54B. The moving portion 55 has a U shape that is open to the front in a side view. The moving portion 55 includes a coupling portion 510, a plurality of guide shafts 521, 522, 523, and 524, a plurality of support shafts 531, 532, 533, and 534, and the press head 540. The coupling portion 510 has a cuboid shape, and is coupled to the upper end of the cylinder rod 54B shown in FIG. 14.

The guide shaft 521 is disposed at the front right corner of the coupling portion 510, and extends downward from the lower surface of the coupling portion 510. A guide block 59A is fixed to the front right corner inside the housing 51 shown in FIG. 12. A guide hole 591 is provided in the guide block 59A. The guide hole 591 penetrates the guide block 59A in the up-down direction. The guide shaft 521 is inserted into the guide hole 591. In this way, the guide shaft 521 is supported on the guide block 59A so as to be able to move in the up-down direction along the guide hole 591.

In a similar manner, the guide shafts 522, 523, and 524 are disposed at the front left corner, the rear right corner, and the rear left corner of the coupling portion 510, respectively, and extend downward from the lower surface of the coupling portion 510. Guide blocks 59B, 59C, and 59D are fixed to the front left corner, the rear right corner, and the rear left corner, respectively, inside the housing 51 shown in FIG. 12. Guide holes 592, 593, and 594 are respectively provided in the guide blocks 59B, 59C, and 59D. The guide holes 592, 593, and 594 respectively penetrate the guide blocks 59B, 59C, and 59D in the up-down direction.

The guide shafts 522, 523, and 524 are respectively inserted into the guide holes 592, 593, and 594. In this way, the guide shafts 522, 523, and 524 are respectively supported on the guide blocks 59B, 59C, and 59D so as to be able to move in the up-down direction along the guide holes 592, 593, and 594.

The plurality of support shafts 531 to 534 are respectively disposed at the rear portion of the coupling portion 510. Each of the plurality of support shafts 531 to 534 has a circular column shape, and extends upward from the upper surface of the coupling portion 510. The support shaft 531 is disposed between the center and the right end of the coupling portion 510 in the left-right direction. The support shaft 532 is aligned to the left of the support shaft 531. The support shaft 532 is disposed between the center and the left end of the coupling portion 510 in the left-right direction.

The support shaft 533 is aligned to the rear of the support shaft 531. The support shaft 533 is disposed between the center and the right end of the coupling portion 510 in the left-right direction. The support shaft 534 is aligned to the rear of the support shaft 532, and is aligned to the left of the support shaft 533. The support shaft 534 is disposed between the center and the left end of the coupling portion 510 in the left-right direction.

The press head 540 is disposed at the upper end of the moving portion 55, and is supported by the plurality of support shafts 531 to 534. In the up-down direction, the press head 540 is disposed at the same height as the opening 51A shown in FIG. 11.

The press head 540 includes an upper plate 541, a right plate 542, and a left plate 543. The upper plate 541 is fixed to each of the upper ends of the plurality of support shafts 531 to 534. The upper plate 541 extends in the front-rear direction and the left-right direction, and has a rectangular shape in a plan view. The upper plate 541 extends from a position further to the rear than the plurality of support shafts 533 and 534 to a position further to the front than the plurality of support shafts 531 and 532. The upper plate 541 extends from a position further to the right than the plurality of support shafts 531 and 533 to a position further to the left than the plurality of support shafts 532 and 534.

The upper plate 541 includes a plurality of blocks 581, 582, and 583. Each of the blocks 581 to 583 protrudes upward from an upper surface 541A of the upper plate 541. The block 581 is disposed at the right end of the upper plate 541, and extends in the front-rear direction. The block 581 includes a press surface 581A. The press surface 581A is provided on the upper surface of the block 581. The press surface 581A has a flat surface shape and faces upward.

The block 582 is disposed at the left end of the upper plate 541, and extends in the front-rear direction. The block 582 includes a press surface 582A. The press surface 582A is provided on the upper surface of the block 582. The press surface 582A has a flat surface shape and faces upward.

The block 583 is disposed between the block 581 and the block 582 in the left-right direction, and, in the front-rear direction, is disposed at a position in the vicinity of the rear ends of each of the blocks 581 and 582. The block 583 has a circular column shape that extends in the up-down direction. The block 583 includes a press surface 583A. The press surface 583A is provided on the upper surface of the block 583. The press surface 583A has a flat surface shape and faces upward.

A positional relationship, in the front-rear direction, of the blocks 581, 582, and 583 is the same as a positional relationship, in the front-rear direction, of the blocks 91, 92, and 93 shown in FIG. 6. A positional relationship, in the left-right direction, of the blocks 581, 582, and 583 is the same as a positional relationship, in the left-right direction, of the blocks 91, 92, and 93 shown in FIG. 6. A height relationship, in the up-down direction, of the blocks 581, 582, and 583 with respect to the upper surface 541A of the upper plate 541 is the same as a height relationship, in the up-down direction, of the blocks 91, 92, and 93 with respect to the lower surface 11B of the platen plate 11 shown in FIG. 6.

The right plate 542 extends downward from the right end of the upper plate 541. A perpendicular portion 542A and an inclined portion 542B are provided on the front end of the right plate 542. The perpendicular portion 542A extends downward from the upper end of the right plate 542. The inclined portion 542B extends from the lower end of the perpendicular portion 542A so as to be inclined downward the further toward the rear.

The left plate 543 extends downward from the left end of the upper plate 541. A perpendicular portion 543A and an inclined portion 543B are provided on the front end of the left plate 543. The perpendicular portion 543A extends downward from the upper end of the left plate 543. The inclined portion 543B extends from the lower end of the perpendicular portion 543A so as to be inclined downward the further toward the rear.

The left plate 543 includes guide blocks 553 and 554. The guide block 553 is fixed to the front end of the left plate 543, and is disposed in the vicinity of the front end of the block 582 in the front-rear direction. The guide block 553 has a cuboid shape, and protrudes to the left from the left surface of the left plate 543. A guide surface 553A is provided on the front surface of the guide block 553. The guide surface 553A is inclined to the left the further toward the rear. A contact surface 553B is provided on the left surface of the guide block 553. The contact surface 553B extends to the rear from the left end of the guide surface 553A, and faces to the left

The guide block 554 is aligned to the rear of the guide block 553, and is disposed in the vicinity of the rear end of the block 582 in the front-rear direction. The guide block 554 has a cuboid shape, and protrudes to the left from the left surface of the left plate 543. A contact surface 554A is provided on the left surface of the guide block 554. The contact surface 554A extends to the rear from the front left corner of the guide block 554, and faces to the left.

In a similar manner, the right plate 542 includes guide blocks 551 and 552 shown in FIG. 18. The guide block 551 is fixed to the front end of the right plate 542, and is disposed in the vicinity of the front end of the block 581 in the front-rear direction. The guide block 551 has a cuboid shape, and protrudes to the right from the right surface of the right plate 542. A guide surface 551A is provided on the front surface of the guide block 551. The guide surface 551A is inclined to the right the further toward the rear. A contact surface 551B is provided on the right surface of the guide block 551. The contact surface 551B extends to the rear from the right end of the guide surface 551A, and faces to the right.

The guide block 552 is aligned to the rear of the guide block 551, and is disposed in the vicinity of the rear end of the block 581 in the front-rear direction. The guide block 552 has a cuboid shape, and protrudes to the right from the right surface of the right plate 542. A contact surface 552A is provided on the right surface of the guide block 552. The contact surface 552A extends to the rear from the front right corner of the guide block 552, and faces to the right.

The fixed plate 56 is disposed higher than the press head 540, and is fixed to the housing 51 shown in FIG. 11. Thus, in the up-down direction, the position of the fixed plate 56 with respect to the base 53 is constant irrespective of the driving of the cylinder 54. The fixed plate 56 extends in the front-rear direction and the left-right direction, and has a rectangular shape in a plan view. A length of the fixed plate 56 in the left-right direction is greater than a length, in the left-right direction, of the platen plate 11 shown in FIG. 6. A length of the fixed plate 56 in the front-rear direction is greater than a length, in the front-rear direction, of the platen plate 11 shown in FIG. 6. The heaters 57 are heating elements, and are spread around the interior of the fixed plate 56. The heaters 57 generate heat as a result of being energized, and heat the fixed plate 56.

Setting of the platen 10 on the press head 540 and a pressing operation will be described. As shown in FIG. 11, the platen 10 is transferred from the transfer mechanism 84 to the branched path 88 in the state in which the rear of the platen 10 is oriented toward the rear of the press machine 5, and is conveyed by the branched path 88 from the front to the rear.

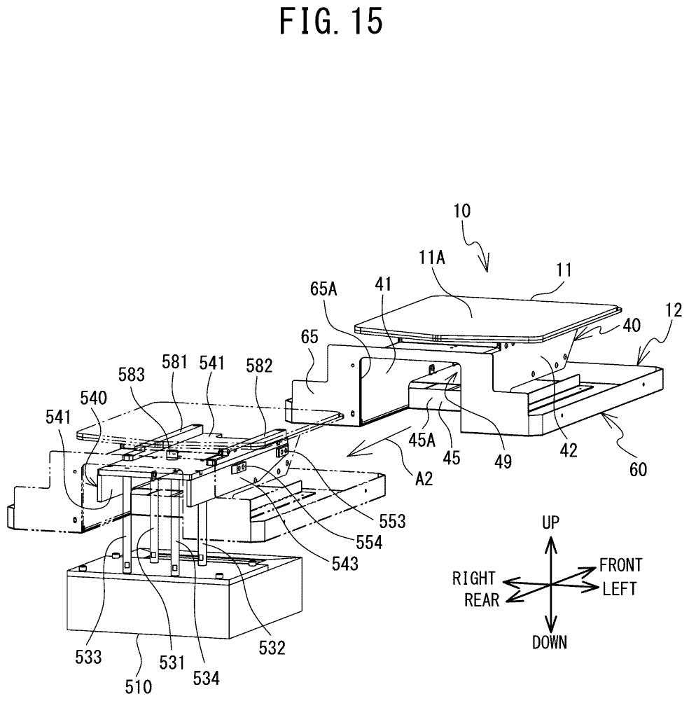

FIG. 16 shows the press head 540 using solid lines, and shows the platen 10 using virtual lines. In the platen 10, FIG. 16 shows the blocks 91 to 98 hidden by the platen plate 11 using hidden lines. As shown in FIG. 15 and FIG. 16, when the platen 10 is conveyed as far as the press head 540, the press head 540 is inserted into the insertion space 49.

As shown by an arrow A2, the direction in which the platen 10 is set on the press head 540 is the conveyance direction of the platen 10 when the press head 540 is inserted into the platen 10, and is the direction from the front to the rear. In other words, the front of the platen 10 is upstream in the direction in which the platen 10 is set on the press head 540, and the rear of the platen 10 is downstream in the direction in which the platen 10 is set on the press head 540.

When the front end of the press head 540 is positioned at the recess portion 65A, the guide surface 551A of the guide block 551 shown in FIG. 16 comes into contact with the right edge of the recess portion 65A shown in FIG. 15, or the guide surface 553A of the guide block 553 shown in FIG. 16 comes into contact with the left edge of the recess portion 65A shown in FIG. 15. In this way, in the course of the press head 540 being inserted into the insertion space 49, the position of the platen 10 with respect to the press head 540 in the left-right direction is guided.

As shown in FIG. 15, when the platen 10 moves further to the rear, a rear surface 45A of the contact plate 45 comes into contact with the front ends of each of the support shafts 531 and 532. In this way, the position of the platen 10 with respect to the press head 540 in the front-rear direction is determined. A distance, in the front-rear direction, between the rear surface 45A of the contact plate 45 and the front end of the platen 10 is shorter than a distance, in the front-rear direction, between each of the support shafts 531 and 532 and the opening 51A shown in FIG. 11. Thus, in the state in which the rear surface 45A of the contact plate 45 is in contact with the front ends of each of the support shafts 531 and 532, the whole of the platen 10 is disposed inside the housing 51. In other words, in the state in which the rear surface 45A of the contact plate 45 is in contact with the front ends of each of the support shafts 531 and 532, the platen 10 does not emerge to the outside of the housing 51 via the opening 51A shown in FIG. 11.

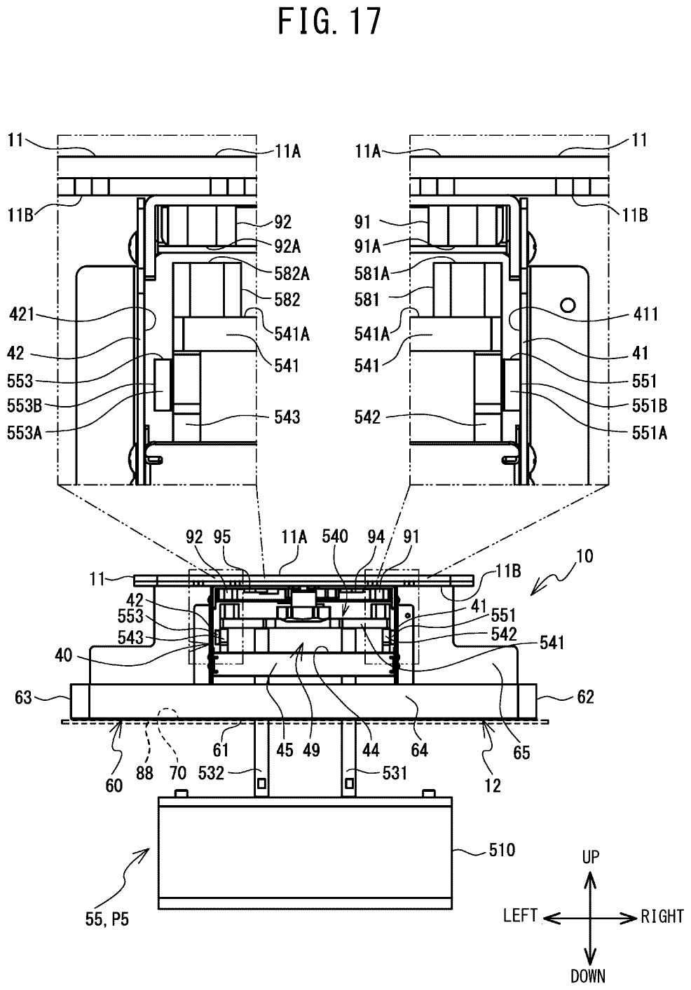

As shown in FIG. 16 and FIG. 17, in the left-right direction, a distance between the contact surface 551B and the contact surface 553B is the same as a distance between the contact surface 552A and the contact surface 554A. The distance between the contact surface 551B and the contact surface 553B, and the distance between the contact surface 552A and the contact surface 554A, in the left-right direction, are slightly smaller than a distance, in the left-right direction, between the right surface of the right plate 41 and the left surface of the left plate 42. Thus, the left surface 411 of the right plate 41 comes into contact with each of the contact surface 551B of the guide block 551 and the contact surface 552B of the guide block 552, or the right surface 421 of the left plate 42 comes into contact with each of the contact surface 553B of the guide block 553 and the contact surface 554B of the guide block 554. For example, FIG. 17 shows a state in which the contact surface 551B of the guide block 551 is in contact with the left surface 411 of the right plate 41.

As a result of the left surface 411 of the right plate 41 coming into contact with each of the contact surface 551B of the guide block 551 and the contact surface 552B of the guide block 552, or the right surface 421 of the left plate 42 coming into contact with each of the contact surface 553B of the guide block 553 and the contact surface 554B of the guide block 554, the position of the platen 10 with respect to the press head 540 is determined in the left-right direction. As described above, the platen 10 is set on the press head 540.

As shown in FIG. 16 and FIG. 17, in the state in which the platen 10 is set on the press head 540, the press surface 91A faces the press surface 581A from above with an interval therebetween, the press surface 92A faces the press surface 582A from above with an interval therebetween, and the press surface 93A faces the press surface 583A from above with an interval therebetween.

In the present embodiment, in the state in which the platen 10 is set on the press head 540, all of the support surfaces 94A, 95A, and 96A are disposed further to the left than the left end of the block 581, and are disposed further to the right than the right end of the block 582. All of the support surfaces 94A, 95A, and 96A are disposed further to the front than the front end of the block 583. Thus, the support surfaces 94A, 95A, and 96A do not come into contact with the blocks 581 to 583.

In the state in which the platen 10 is set on the press head 540, in a plan view or in a front view, the right plate 41 is disposed to the right with respect to the whole of the press head 540. In other words, the press head 540 does not interfere with the right plate 41. That is, in a plan view or in a front view, the press head 540 does not emerge to the right from the right plate 41.

In the state in which the platen 10 is set on the press head 540, in a plan view or in a front view, the left plate 42 is disposed to the left with respect to the whole of the press head 540. In other words, the press head 540 does not interfere with the left plate 42. That is, in a plan view or in a front view, the press head 540 does not emerge to the left from the left plate 42.

FIG. 18 and FIG. 19 show portions of the moving portion 55 that are hidden by the platen 10 using virtual lines. As shown in FIG. 18, in the state in which the platen 10 is set on the press head 540, the platen plate 11 is disposed between the press head 540 and the fixed plate 56 in the up-down direction. In the state in which the platen 10 is set on the press head 540, in a right side view, the whole of the press head 540 is covered from the right by the right plate 41. For example, the perpendicular portion 41A and the inclined portion 41B of the right plate 41 are disposed further to the front than the perpendicular portion 542A and the inclined portion 542B of the right plate 542. In a similar manner, in a left side view, the whole of the press head 540 is covered from the left by the left plate 42 shown in FIG. 16. For example, the perpendicular portion 42A and the inclined portion 42B of the left plate 42 are disposed further to the front than the perpendicular portion 543A and the inclined portion 543B of the left plate 543.

As shown in FIG. 18 and FIG. 19, the pressing operation is an operation to press the platen plate 11 against the fixed plate 56 from below, using the press head 540. The pressing operation is performed in the state in which the platen 10 is set on the press head 540. In the state in which the platen 10 is set on the press head 540, the placement surface 11A of the platen plate 11 faces the lower surface of the fixed plate 56 in the up-down direction. In the present embodiment, the pressing operation is performed in a state in which the fixed plate 56 has been heated by the heaters 57.

The cylinder 54 moves the moving portion 55 in the up-down direction to a stand-by position P5 shown in FIG. 18 and a pressing position P6 shown in FIG. 19. When the driving of the cylinder 54 is stopped and the cylinder rod 54B is disposed at the lower end of a movement range of the cylinder rod 54B, the moving portion 55 is disposed at the stand-by position P5 shown in FIG. 18. In this case, the print medium M on the platen plate 11 is separated downward from the lower surface of the fixed plate 56.

When the pressing operation is performed, the cylinder rod 54B moves upward due to the driving of the cylinder 54. In this way, the moving portion 55 moves from the stand-by position P5 shown in FIG. 18 to the pressing position P6 shown in FIG. 19. In the course of the moving portion 55 moving from the stand-by position P5 to the pressing position P6, the press surface 581A comes into contact with the press surface 91A from below, the press surface 582A comes into contact with the press surface 92A from below, and the press surface 583A comes into contact with the press surface 93A from below.

As a result of the moving portion 55 moving further upward toward the pressing position P6, the press head 540 lifts up the platen 10 from the branched path 88. When the moving portion 55 has moved to the pressing position P6, the print medium M on the platen plate 11 is sandwiched between the fixed plate 56 and the platen plate 11 by the press head 540. In this way, the press head 540 presses the print medium M upward from below, against the fixed plate 56. The pressing operation is performed by the press head 540 in the manner described above.

The electrical configuration of the print system 1 will be described with reference to FIG. 20. The print system 1 is provided with a system computer 100 and a printer computer 2A. The system computer 100 is provided on a control board (not shown in the drawings), for example, and controls each of the application device 3, the press machine 5, and the conveyance device 7. The printer computer 2A is provided in the printer 2, and controls the printer 2. The system computer 100 and the printer computer 2A communicate with each other in a wired or wireless manner.

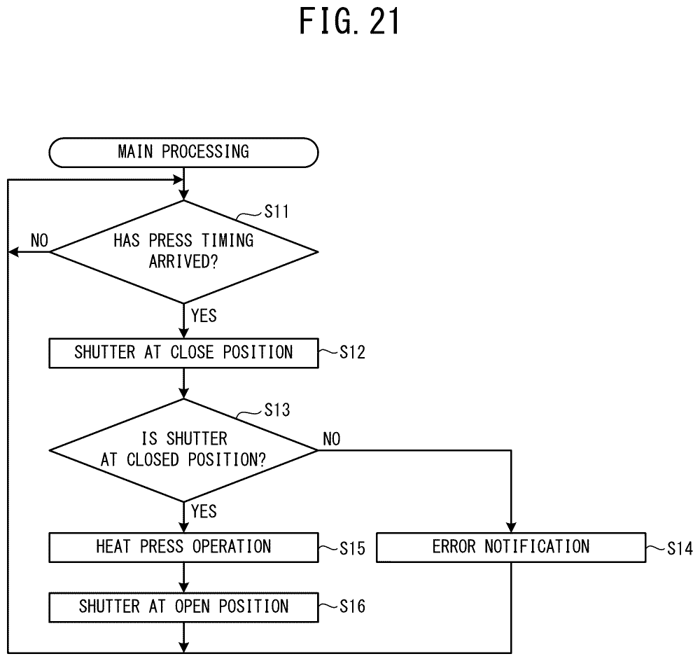

The system computer 100 is provided with a CPU 101, a memory 102, an input portion 103, and a display 104. The CPU 101 functions as a processor. The CPU 101 is electrically connected to the memory 102, the input portion 103, and the display 104. The memory 102 includes a non-volatile memory and stores various information. For example, the memory 102 stores programs. The programs include a control program for executing main processing to be described later and shown in FIG. 21, and the programs are executed by the CPU 101.

The input portion 103 is a user interface, and includes a touch panel, a power supply button, and the like. The user operates the input portion 103 and inputs various commands to the system computer 100. The display 104 displays various information by control of the CPU 101.

The CPU 101 is electrically connected to each of the drive portion 3A, the heaters 57, the opening/closing motor 511, an open/closed sensor 512, the conveyance motor 7A, the lifting motor 7B, a position sensor 7C, and the printer computer 2A, via an input/output interface 105. The drive portion 3A is driven by control of the CPU 101, and causes the treatment liquid to be sprayed from the application portion 31 shown in FIG. 7. The heaters 57 generate heat by control of the CPU 101, and heat the fixed plate 56 shown in FIG. 13. The opening/closing motor 511 is driven by control of the CPU 101 and moves the shutter 52 shown in FIG. 11 and FIG. 12 to the open position P3 and the closed position P4.

The open/closed sensor 512 is a limit switch, a proximity sensor, an optical sensor, or the like, and is provided at the edge of the opening 51A shown in FIG. 11, for example. The open/closed sensor 512 detects the position of the shutter 52 shown in FIG. 12, and outputs a signal indicating a detection result to the CPU 101. In the present embodiment, the open/closed sensor 512 detects the shutter 52 disposed at the closed position P4 shown in FIG. 12.

A number of the conveyance motors 7A is a plurality thereof. The plurality of conveyance motors 7A are respectively provided at each of the outward path 72, the return path (not shown in the drawings), the elevator mechanisms 74 and 75, the transfer mechanisms 83 to 85, and the branched paths 87 and 88 shown in FIG. 7. Each of the plurality of conveyance motors 7A is driven by control of the CPU 101 and conveys the platen 10. For example, the conveyance motor 7A of the outward path 72 conveys the platen 10 on the outward path 72 as a result of being driven.

A number of the lifting motors 7B is a plurality thereof. The plurality of lifting motors 7B are respectively provided at each of the elevator mechanisms 74 and 75 and the transfer mechanisms 83 to 85 shown in FIG. 7. Each of the plurality of lifting motors 7B is driven by control of the CPU 101 and raises and lowers the platen 10. For example, the lifting motor 7B of the elevator mechanism 74 raises and lowers the platen 10 on the elevator mechanism 74 as a result of being driven.

A number of the position sensors 7C is a plurality thereof. The plurality of position sensors 7C are respectively, a limit switch, a proximity sensor, an optical sensor, or the like, and are provided at each of the outward path 72, the return path (not shown in the drawings), the elevator mechanisms 74 and 75, the transfer mechanisms 83 to 85, and the branched paths 87 and 88 shown in FIG. 7. The plurality of position sensors 7C detect the platens 10 present at the positions at which the position sensors 7C are respectively provided, and output a signal indicating a detection result to the CPU 101. For example, when the position sensor 7C of the branched path 88 detects the platen 10 on the branched path 88, the position sensor 7C outputs a signal to the CPU 101 indicating that the platen 10 is present on the branched path 88.

The main processing will be described with reference to FIG. 21. When the power supply to the system computer 100 is turned on, the CPU 101 starts the main processing by reading out and operating the control program from the memory 102. In the main processing, control of the application device 3, control of the press machine 5, control of the conveyance device 7, and the like is performed. Hereinafter, processing relating to the control of the press machine 5, of the main processing, will be described. At the start of the main processing, it is assumed that the shutter 52 is positioned at the open position P3 shown in FIG. 11.

When the main processing is started, the CPU 101 determines whether a press timing, which is a timing for performing the pressing operation by the press head 540, has arrived (S11). The determination as to whether the press timing has arrived is performed based on various information. For example, the CPU 101 determines that the press timing has arrived when the CPU 101 acquires the signal from the position sensor 7C of the branched path 88 indicating that the platen 10 is present on the branched path 88. For example, via the input portion 103, the user inputs a heat press command for performing the pressing operation, to the system computer 100, and when the CPU 101 acquires the input heat press command, the CPU 101 determines that the press timing has arrived.

When the press timing has not yet arrived (no at S11), the CPU 101 returns the processing to the determination at S11, and repeats the determination at S11 until the press timing arrives. When the press timing has arrived (yes at S11), the CPU 101 controls the opening/closing motor 511, and moves the shutter 52 from the open position P3 shown in FIG. 11 toward the closed position P4 shown in FIG. 12 (S12).

The CPU 101 determines that the shutter 52 is disposed at the closed position P4 shown in FIG. 12 based on the detection signal from the open/closed sensor 512 shown in FIG. 20 (S13). As shown in FIG. 15, when the rear surface 45A of the contact plate 45 has come into contact with the front ends of the support shafts 531 and 532, the front end of the platen 10 is disposed further to the rear than the opening 51A shown in FIG. 11, namely, further to the rear than the shutter 52. Thus, the platen 10 does not emerge to the outside of the housing 51 from the opening 51A. As a result, the shutter 52 can move from the open position P3 shown in FIG. 11 to the closed position P4 shown in FIG. 12.

On the other hand, when the contact plate 45 is separated, to the front, from the front ends of the support shafts 531 and 532, the front end of the platen 10 is disposed further to the front than the opening 51A shown in FIG. 11, namely, further to the front than the shutter 52. Thus, in a state in which the rear end of the platen 10 is disposed further to the rear than the opening 51A, namely, further to the rear than the shutter 52, the platen 10 emerges to the outside of the housing 51 from the opening 51A. Thus, the shutter 52 collides with the platen 10, from above, in the course of moving from the open position P3 shown in FIG. 11 to the closed position P4 shown in FIG. 12. As a result, the shutter 52 cannot move from the open position P3 shown in FIG. 11 to the closed position P4 shown in FIG. 12. In other words, the shutter 52 is disposed at the closed position P4 shown in FIG. 12 means that the rear surface 45A of the contact plate 45 shown in FIG. 15 is in contact with the front ends of the support shafts 531 and 532. Thus, this can be referred to as being that the open/closed sensor 512 shown in FIG. 20 detects that the rear surface 45A of the contact plate 45 shown in FIG. 15 is in contact with the front ends of the support shafts 531 and 532.

When the shutter 52 is not disposed at the closed position P4 shown in FIG. 12 (no at S13), there is a possibility that a setting abnormality has occurred in setting the platen 10 on the press head 540 shown in FIG. 15. In this case, the CPU 101 performs error notification (S14). The error notification notifies the user that the rear surface 45A of the contact plate 45 is not in contact with the front ends of the support shafts 531 and 532, namely, that there is a possibility that the setting abnormality of the platen 10 on the press head 540 has occurred. In the error notification, the CPU 101 may display error content on the display 104, or may output an error noise from a speaker (not shown in the drawings). When the error is resolved, the CPU 101 returns the processing to the determination at S11. In this way, when the open/closed sensor 512 does not detect that the rear surface 45A of the contact plate 45 is in contact with the front ends of the support shafts 531 and 532, the CPU 101 prohibits the execution of the pressing operation.

When the shutter 52 is disposed at the closed position P4 shown in FIG. 12 (yes at S13), the CPU 101 controls the heaters 57 and the cylinder 54 shown in FIG. 18 and FIG. 19, and performs the surface processing (S15). In the surface processing, the pressing operation by the press head 540 is performed in the state in which the fixed plate 56 is heated by the heaters 57. The surface processing is performed, for example, from the start of the pressing operation until a predetermined press time period has elapsed. In this way, when the open/closed sensor 512 detects that the rear surface 45A of the contact plate 45 is in contact with the front ends of the support shafts 531 and 532, the CPU 101 allows the execution of the pressing operation.

When the surface processing has ended, the CPU 101 controls the opening/closing motor 511 shown in FIG. 20, and moves the shutter 52 from the closed position P4 shown in FIG. 12 to the open position P3 shown in FIG. 11 (S16). In this case, the conveyance device 7 is controlled, and the platen 10 is discharged from the housing 51 via the opening 51A and transferred to the transfer mechanism 84. The CPU 101 returns the processing to the determination at S11.

As described above, in the present embodiment, the platen 10 is set on the press head 540 that performs the pressing operation that presses the platen 10 upward against the fixed plate 56. The platen 10 is provided with the platen plate 11, the support base 12, and the press surfaces 91A, 92A, and 93A. The platen plate 11 is the surface that faces upward, and includes the placement surface 11A on which the print medium M is placed. The support base 12 is disposed lower than the platen plate 11. The support base 12 includes the support pillar 40 that supports the platen plate 11 from below. The press surfaces 91A, 92A, and 93A are provided higher than the lowermost surface of the support base 12, and are surfaces that face downward. The press head 540 comes into contact with the press surfaces 91A, 92A, and 93A when the press head 540 performs the pressing operation in the state in which the platen 10 is set on the press head 540.

According to this configuration, the press surfaces 91A, 92A, and 93A are provided higher than the lowermost surface of the support base 12. Pressure generated by the pressing operation is less likely to act on portions, of the support base 12, that are lower than the press surfaces 91A, 92A, and 93A compared to portions that are higher than the press surfaces 91A, 92A, and 93A. Thus, of the support base 12, compared to the portions that are higher than the press surfaces 91A, 92A, and 93A, rigidity for resisting the pressure generated by the pressing operation is not required with respect to the portions that are lower than the press surfaces 91A, 92A, and 93A. Thus, the platen 10 contributes to suppressing high rigidity of the platen 10 as a whole. The portions, of the support base 12, that are lower than the press surfaces 91A, 92A, and 93A are, for example the tray 60, the connection plate 44, or the contact plate 45. Thus, for example, the tray 60 may be made lighter, such that the rigidity of the tray 60 is less than that of the platen plate 11. In this case, the platen 10 as a whole becomes lighter, and a withstanding load of the conveyance device 7 is suppressed. The platen 10 is more easily handled by the user.

In the above-described embodiment, the press surfaces 91A, 92A, and 93A are parallel to the placement surface 11A. Thus, the platen 10 contributes to causing the pressure generated by the pressing operation to act evenly over the whole of the print medium M.

In the above-described embodiment, the press surfaces 91A, 92A, and 93A are provided to be higher than the lower surface of the tray 60. In this case, the pressure generated by the pressing operation is unlikely to act on the tray 60. As a result, the rigidity for resisting the pressure generated by the pressing operation is not required in the tray 60. Thus, the platen 10 contributes to suppressing an increase in the rigidity of the tray 60.

In the above-described embodiment, in the left-right direction, the right plate 41 and the left plate 42 are provided at positions where the platen plate 11 is interposed therebetween. In this case, the right plate 41 and the left plate 42 support the platen plate 11 at two locations on either side of the center of the platen plate 11 in the left-right direction. Thus, the platen 10 contributes to suppressing a possibility of the placement surface 11A becoming tilted in the front-rear direction or the left-right direction, more than when the platen plate 11 is supported at one location by the support pillar 40, or more than when the right plate 41 and the left plate 42 support the platen plate 11 at two locations that are not on either side of the center of the platen plate 11.

If, for example, the press surfaces 91A, 92A, and 93A are provided further to the right than the right plate 41, the left portion of the print medium M is further away from the press surfaces 91A, 92A, and 93A in the left-right direction. In this case, there is a possibility that the pressure generated by the pressing operation is less likely to act on the left portion of the print medium M. In the above-described embodiment, the press surfaces 91A, 92A, and 93A are provided between the right plate 41 and the left plate 42 in the left-right direction. In this case, the right plate 41 and the left plate 42 are provided at positions where the center of the platen plate 11 is interposed therebetween in the left-right direction, and thus, the press surfaces 91A, 92A, and 93A are disposed in the vicinity of the center of the platen plate 11 in the left-right direction, compared to a case in which the press surfaces 91A, 92A, and 93A are provided further to the right than the right plate 41 or further to the left than the left plate 42. Thus, the platen 10 contributes to causing the pressure generated by the pressing operation to act evenly over the whole of the print medium M.

The pressure generated by the pressing operation acts on the press surfaces 91A, 92A, and 93A. Thus, there is a possibility that the press surfaces 91A, 92A, and 93A may be deformed by the pressing operation. If, for example, the press surfaces 91A, 92A, and 93A are provided on the same position as the support surfaces 94A, 95A, and 96A, there is a possibility that deformation of the support surfaces 94A, 95A, and 96A may have a negative impact on the printing by the printer 2. In the above-described embodiment, the press surfaces 91A, 92A, and 93A are provided at different positions from the support surfaces 94A, 95A, and 96A. Thus, the platen 10 contributes to suppressing an impact on the printing by the printer 2 caused by deformation of the press surfaces 91A, 92A, and 93A by the pressing operation.

If, for example, the press surfaces 91A and 92A are present between the support surface 94A and the support surface 95A, there is a possibility that the platen plate 11 may be deformed such that the outer sides thereof sag downward as a result of the pressing operation. When the conveyance support base 23 supports the platen 10, using the support surfaces 94A, 95A and 96A, in the state in which the outer sides of the platen plate 11 sag downward, there is a possibility that, in the up-down direction, the distance between the nozzle surface 26A and the print medium M on the platen plate 11 may vary. When the printing is performed by the printer 2 in the state in which the distance between the nozzle surface 26A and the print medium M on the platen plate 11 in the up-down direction varies, there is a possibility that variations may occur in an image quality of the printing on the print medium M. In the above-described embodiment, the press surface 91A and the press surface 92A are provided at positions where the support surfaces 94A, 95A, and 96A are interposed therebetween. In this case, compared to a case in which the press surfaces 91A and 92A are present between the support surface 94A and the support surface 95A, for example, the outer sides of the platen plate 11 are suppressed from being deformed so as to sag downward as a result of the pressing operation. Thus, the platen 10 contributes to the conveyance support base 23 supporting the platen 10, using the support surfaces 94A, 95A, and 96A, in a state in which the impact of the sagging of the outer sides of the platen plate 11, which may occur as a result of the pressing operation, is small.

If, for example, in the state in which the platen 10 is set on the press head 540, the front end of the support pillar 40 is disposed further to the rear than the front end of the press head 540, there is a possibility that the front end of the press head 540 may come into contact with the print medium M, and that the print medium M may thus become displaced with respect to the placement surface 11A, or wrinkles may occur in the print medium M. Thus, when the press head 540 performs the pressing operation in a state in which the front end of the press head 540 is in contact with the print medium M, there is a possibility that this will have an adverse impact on the print medium M. In the above-described embodiment, in the state in which the platen 10 is set on the press head 540, the front end of the support pillar 40 is disposed further to the front than the front end of the press head 540. Thus, the contact of the press head 540 with the print medium M is suppressed. As a result, the platen 10 contributes to suppressing the possibility of the adverse impact on the print medium M by the pressing operation.

If, for example, in the state in which the platen 10 is set on the press head 540, the support pillar 40 is disposed so as to intersect the press head 540 in the left-right direction, there is a possibility that one or both ends of the press head 540 in the left-right direction may come into contact with the print medium M, and the print medium M may become displaced with respect to the placement surface 11A, or wrinkles may occur in the print medium M. Thus, when the press head 540 performs the pressing operation in a state in which the press head 540 is in contact with the print medium M, there is a possibility that this will have an adverse impact on the print medium M. In the above-described embodiment, in the state in which the platen 10 is set on the press head 540, the right plate 41 is disposed to the right of the whole of the press head 540, and the left plate 42 is disposed to the left of the whole of the press head 540. Thus, the contact of the press head 540 with the print medium M is suppressed. As a result, the platen 10 contributes to suppressing the possibility of the adverse impact on the print medium M by the pressing operation.

In the above-described embodiment, the blocks 91 to 93 are replaceably fixed to the lower surface 11B of the platen plate 11. Thus, even if the press surfaces 91A, 92A, and 93A become deformed, the user can replace the blocks 91 to 93. Thus, the platen 10 contributes to the easy repair of the platen 10.

If, for example, the position of the platen 10 with respect to the press head 540 in the front-rear direction varies, there is a possibility that the pressure acting on the print medium M as a result of the pressing operation may vary in the front-rear direction. In the above-described embodiment, the support pillar 40 includes the rear surface 45A of the contact plate 45. The rear surface 45A is provided at a position different from the press surfaces 91A, 92A, and 93A. In the state in which the platen 10 is set on the press head 540, the rear surface 45A is in contact with the front ends of each of the support shafts 531 and 532. In this case, as a result of the rear surface 45A being in contact with the front ends of each of the support shafts 531 and 532, the position of the platen 10 with respect to the press head 540 is easily determined in the front-rear direction. Thus, the platen 10 contributes to causing the pressure generated by the pressing operation to act evenly over the whole of the print medium M.

In the above-described embodiment, when the open/closed sensor 512 detects that the rear surface 45A has come into contact with the support shafts 531 and 532, the CPU 101 allows the execution of the pressing operation. As a result of the rear surface 45A coming into contact with the support shafts 531 and 532, the position of the platen 10 with respect to the press head 540 is easily determined in the front-rear direction. Thus, the platen 10 contributes to suppressing the pressing operation from being performed in a state in which the position of the platen 10 with respect to the press head 540, in the front-rear direction, is not determined.

In the above-described embodiment, the fixed plate 56 is an example of the “fixed plate” of the present disclosure. A unit of the press head 540 and support shafts 531 and 532 is an example of the “press head” of the present disclosure. The platen 10 is an example of the “platen” of the present disclosure. The print medium M is an example of the “print medium” of the present disclosure. The placement surface 11A is an example of the “placement surface” of the present disclosure. The platen plate 11 is an example of the “platen plate” of the present disclosure. The support pillar 40 is an example of the “support pillar” of the present disclosure. The support base 12 is an example of the “platen support base” of the present disclosure. The press surfaces 91A, 92A, and 93A are an example of the “press surface” of the present disclosure.

The tray 60 is an example of the “tray” of the present disclosure. The right plate 41 is an example of the “first support pillar” of the present disclosure. The left plate 42 is an example of the “second support pillar” of the present disclosure. The direction from the front direction to the rear direction of the platen 10 is an example of the “set direction” of the present disclosure. The left-right direction of the platen 10 is an example of the “width direction” of the present disclosure. The printer 2 is an example of the “printer” of the present disclosure. The conveyance support base 23 is an example of the “conveyance support base” of the present disclosure. The support surface 94A, 95A, and 96A are an example of the “printer support surface” of the present disclosure. The inkjet heads 26 are an example of the “print head” of the present disclosure. The press surface 91A is an example of the “first press surface” of the present disclosure. The press surface 92A is an example of the “second press surface” of the present disclosure.

The blocks 91, 92, and 93 are an example of the “block” of the present disclosure. The rear surface 45A of the contact plate 45 is an example of the “contact surface” of the present disclosure. The press machine 5 is an example of the “press machine” of the present disclosure. A unit of the press machine 5 and the platen 10, or a unit of the press machine 5, the platen 10, and the system computer 100 is an example of the “press unit” of the present disclosure. The CPU 101 is an example of the “processor” of the present disclosure. The open/closed sensor 512 is an example of the “sensor” of the present disclosure.

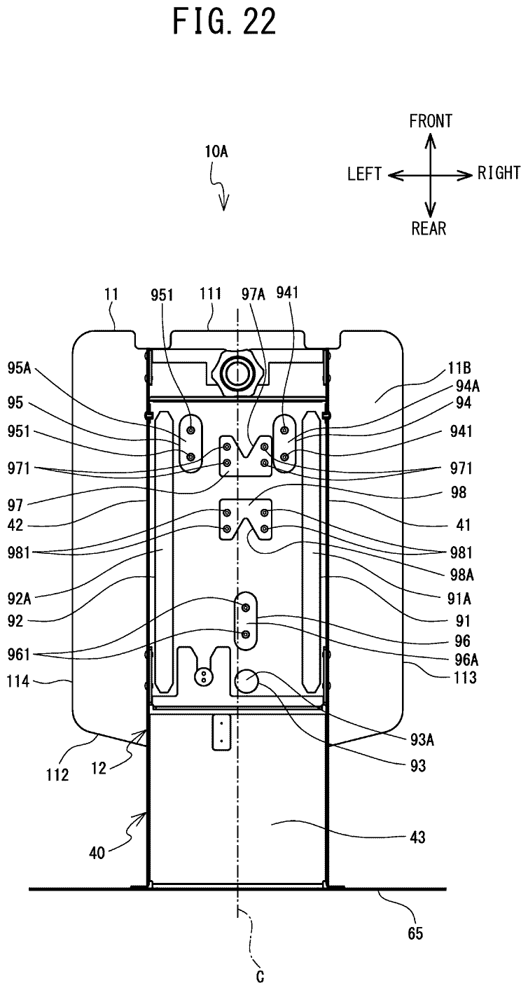

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The above-described embodiment and each of modified examples may be combined with each other insofar as no contradictions arise. A platen 10A will be described with reference to FIG. 22. In FIG. 22, members of the platen 10A having the equivalent function as each of the members of the platen 10 will be allocated the same reference signs as the above-described embodiment, and a description thereof will be omitted.

In the platen 10A, the press surfaces 91A, 92A, and 93A are provided integrally with the lower surface 11B of the platen plate 11. In other words, the blocks 91 to 93 are not fixed to the lower surface 11B of the platen plate 11 with the screws 911, 921, and 931 shown in FIG. 6, and are formed integrally with the platen plate 11. That is, the blocks 91 to 93 cannot be replaced with respect to the lower surface 11B of the platen plate 11. In this case, the platen 10A contributes to reducing a number of components of the platen 10A, in terms of not needing the screws 911, 921, and 931, for example.

In the above-described embodiment, the press machine 5 may be provided with other sensors in place of or in addition to the open/closed sensor 512. The other sensor is provided on the moving portion 55, for example, and detects that the platen 10 has come into contact with the front ends of the support shafts 531 and 532. In this case, in the processing at S13, the CPU 101 may allow the execution of the pressing operation in the surface processing (S15) when it is detected by the other sensor that the front ends of the support shafts 531 and 532 have come into contact with the platen 10 (yes at S13). In the processing at S13, the CPU 101 may prohibit the execution of the pressing operation in the surface processing (S15) when it is not detected by the other sensor that the front ends of the support shafts 531 and 532 have come into contact with the platen 10 (no at S13).

In the above-described embodiment, the shape, the opening and closing direction, and the like of the shutter 52 may be changed as appropriate. The shutter 52 need not necessarily completely cover the opening 51A when the shutter 52 is at the closed position P4. The press machine 5 may omit the shutter 52. In the above-described embodiment, the cylinder 54 may be a hydraulic cylinder. The press machine 5 may raise and lower the moving portion 55 using a different mechanism from the cylinder 54.

In the above-described embodiment, in the state in which the platen 10 is set on the press head 540, the rear surface 45A of the contact plate 45 may be separated, to the front, from the front ends of each of the support shafts 531 and 532. In the state in which the platen 10 is set on the press head 540, the left surface 411 of the right plate 41 may be separated, to the left, from each of the guide blocks 551 and 552, and the right surface 421 of the left plate 42 may be separated, to the right, from each of the guide blocks 553 and 554.

The shape, arrangement positions, and number of the blocks 91 to 93 may be changed from those of the above-described embodiment. For example, the blocks 91 to 93 may have a thin plate shape. Each of the blocks 91 and 92 may have a circular column shape. The block 93 may have a rectangular shape that is long in the front-rear direction or the left-right direction. The blocks 91 to 93 may be configured by a single block. In this case, each of the press surfaces 91A, 92A, and 93A may be provided on the lower surface of the single block, or a single press surface may be provided on the lower surface of the single block. The platen 10 may be provided with another press surface in addition to the press surfaces 91A, 92A, and 93A.

The block 91 may be disposed further to the right than the right plate 41. The block 92 may be disposed further to the left than the left plate 42. The block 93 may be disposed further to the front than the block 96, or may be disposed further to the front than each of the blocks 94 and 95. The block 93 may be disposed at a position separated to the left or the right from the center line C. The blocks 91 and 93 may be provided further to the left than the block 95. The blocks 92 and 93 may be provided further to the right than the block 96.

As long as the blocks 91 to 93 are higher than the lowermost surface of the support base 12, the blocks 91 to 93 may be provided at positions different from the lower surface 11B of the platen plate 11. For example, the blocks 91 to 93 may be provided on the lower surface of the connection plate 44. The press surfaces 91A, 92A, and 93A may be inclined with respect to the placement surface 11A.

For example, the press surface 91A may be a shared surface with the support surface 94A. In a similar manner, the press surfaces 92A and 93A may respectively be shared surfaces with the support surfaces 95A and 96A. In other words, the platen 10 may omit the blocks 94 to 96, and the support surface 94A and the press surface 91A may be formed at the lower surface of the block 91 as the shared surface, the support surface 95A and the press surface 92A may be formed at the lower surface of the block 92 as the shared surface, and the support surface 96A and the press surface 93A may be formed at the lower surface of the block 93 as the shared surface.

In the above-described embodiment, in the state in which the platen 10 is set on the press head 540, a part of the press head 540 may emerge to the right of the right plate 41 in a front view. In the state in which the platen 10 is set on the press head 540, a part of the press head 540 may emerge to the left of the left plate 42 in a front view.

In the above-described embodiment, in the state in which the platen 10 is set on the press head 540, a part of the press head 540 may emerge to the front or to the rear of the right plate 41 in a right side view. In the state in which the platen 10 is set on the press head 540, a part of the press head 540 may emerge to the front or to the rear of the left plate 42 in a left side view.

In the above-described embodiment, the support pillar 40 may omit one of the right plate 41 or the left plate 42. The support pillar 40 may have a rod shape extending in the up-down direction. The support pillar 40 may be configured by one or a plurality of rods extending in the up-down direction.

The platen 10 may omit the tray 60. In this case, the lowermost surface of the support base 12 may form the lower ends of each of the right plate 41 and the left plate 42.

In the above-described embodiment, an example is described of a case in which the platen 10 is used in the print system 1. In contrast to this, the platen 10 need not necessarily be used in the print system 1, and may be used as a unit formed of the press machine 5 and the platen 10. For example, the user or a robot may convey the platen 10, and may set the platen 10 on the press head 540.

In the above-described embodiment, the press machine 5 may be disposed further downstream than the printer 2 on the conveyance path of the platen 10. For example, the print system 1 may perform the surface processing after the print processing. The press machine 5 may omit the heaters 57. In other words, the press machine 5 need not necessarily heat the print medium M using the fixed plate 56. The printer 2 may be changed from the inkjet printer, and may be a thermal printer, a laser printer, a UV printer, or the like.

In the above-described embodiment, the system computer 100 controls each of the application device 3, the press machine 5, and the conveyance device 7. In contrast to this, in place of or in addition to the system computer 100, the print system 1 may be respectively provided with a computer controlling the application device 3, a computer controlling the press machine 5, and a computer controlling the conveyance device 7. In this case, for example, the computer controlling the press machine 5 may execute the main processing.

In place of the CPU 101, a microcomputer, application specific integrated circuits (ASICs), a field programmable gate array (FPGA) or the like may be used as a processor. The main processing may be performed as distributed processing by a plurality of the processors. It is sufficient that the non-transitory storage media, such as the memory 102, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the memory 102. In this case, the control program may be stored in a non-transitory storage medium, such as an HDD provided in the server.

What is claimed is:

1. A platen configured to be set on a press head, the press head being configured to perform a pressing operation of pressing upward against a fixed plate, the platen comprising:
a platen plate including a placement surface, the placement surface facing upward, the placement surface being configured to have a print medium placed on the placement surface;
a platen support base disposed lower than the platen plate, the platen support base including a support pillar, the support pillar supporting the platen plate from below; and
a press surface provided higher than a lowermost surface of the platen support base, the press surface facing downward, the press surface being configured for the press head to come into contact with the press surface when the press head performs the pressing operation in a set state, the set state being a state in which the platen is set on the press head.

2. The platen according to claim 1, wherein
the press surface is parallel to the placement surface.

3. The platen according to claim 1, wherein
the platen support base includes a tray,
the tray is disposed higher than a conveyance path of the platen, in a state of the platen being supported by the conveyance path,
the tray is configured to receive a portion, of the print medium placed on the placement surface, dropping down from the placement surface, and
the press surface is provided to be higher than a lower surface of the tray.

4. The platen according to claim 1, wherein
the support pillar includes a first support pillar and a second support pillar, and
the first support pillar and the second support pillar are provided at positions where a center of the platen plate, in a width direction orthogonal to a set direction, is interposed therebetween, the set direction being a direction in which the platen is set on the press head and orthogonal to an up-down direction.

5. The platen according to claim 4, wherein
the press surface is provided between the first support pillar and the second support pillar, in the width direction.

6. The platen according to claim 1, wherein
a printer is provided with a print head and a conveyance support base,
the print head is configured to perform printing on the print medium,
the conveyance support base is configured to support the platen, and is configured to convey the platen to a separated position and a print position,
when the platen is disposed at the separated position, the platen is configured for the placement surface to be disposed at a position separated, in a direction intersecting an up-down direction, from the print head,
when the platen is disposed at the print position, the platen is configured for the placement surface to face the print head in the up-down direction,
a printer support surface is provided on a lower surface, of the platen plate, on an opposite side from the placement surface, the printer support surface being configured for the conveyance support base to come into contact therewith, and
the press surface is provided at a position different from the printer support surface.

7. The platen according to claim 6, wherein
the press surface includes a first press surface and a second press surface, and
the first press surface and the second press surface are provided at positions where the printer support surface is interposed therebetween.

8. The platen according to claim 1, wherein
in a set direction in which the platen is set on the press head, an upstream end of the support pillar is disposed further upstream than an upstream end, in the set direction, of the press head, in the set state.

9. The platen according to claim 1, wherein
in the set state, the support pillar is disposed to one side with respect to a whole of the press head, in a width direction orthogonal to a set direction, the set direction being a direction in which the platen is set on the press head and orthogonal to an up-down direction.

10. The platen according to claim 1, further comprising:
a block configured to be replaceably fixed to a lower surface, of the platen plate, on an opposite side from the placement surface, wherein
the press surface is provided on the block.

11. The platen according to claim 1, wherein
the press surface is provided integrally with a lower surface, of the platen plate, on an opposite side from the placement surface.

12. The platen according to claim 1, wherein
the platen support base includes a contact surface,
the contact surface is configured to contact the press head in the set state, and
the contact surface is provided at a position different from the press surface.

13. A press unit comprising:
a press machine including a press head, the press head being configured to perform a pressing operation of pressing upward with respect to a fixed plate; and
a platen configured to be set on the press head, wherein
the platen includes
a platen plate including a placement surface, the placement surface facing upward, the placement surface being configured to have a print medium placed on the placement surface,
a platen support base disposed lower than the platen plate, the platen support base including a support pillar, the support pillar being supporting the platen plate from below, and
a press surface provided higher than a lowermost surface of the platen support base, the press surface facing downward, the press surface being configured for the press head to come into contact with the press surface when the press head performs the pressing operation in a set state, the set state being a state in which the platen is set on the press head.

14. The press unit according to claim 13, further comprising:
a processor, wherein
the platen support base includes a contact surface, the contact surface being configured to contact the press head in the set state,
the contact surface is provided at a position different from the press surface,
the press machine includes a sensor, the sensor being configured to detect contact between the contact surface and the press head, and
the processor is configured to allow execution of the pressing operation when the contact between the contact surface and the press head is detected by the sensor.
